(19) United States
(12) Patent Application Publication
(10) Pub. No.: US 2026/0230596 A1
(43) Pub. Date: Aug. 6, 2026

(54) ELECTRONIC APPARATUS AND CONTROLLING METHOD THEREOF

(71) Applicant: SAMSUNG ELECTRONICS CO., LTD., Suwon-si (KR)

(72) Inventor: Eungsoo IN, Suwon-si (KR)

(73) Assignee: SAMSUNG ELECTRONICS CO., LTD., Suwon-si (KR)

(21) Appl. No.: 19/464,011

(22) Filed: Jan. 29, 2026

Related U.S. Application Data
(63) Continuation of application No. PCT/KR2025/021108, filed on Dec. 9, 2025.

(30) Foreign Application Priority Data
Jan. 24, 2025 (KR) 10-2025-0011786

(51) Int. Cl. H04N 13/337; H04N 13/324; H04N 13/327; H04N 13/398

(52) U.S. Cl. CPC H04N 13/337; H04N 13/324; H04N 13/327; H04N 13/398

(57) ABSTRACT

An electronic apparatus includes memory storing instructions, at least one processor, an image output module, a variable polarization film, and an illumination sensor, wherein the instructions cause the electronic apparatus to obtain first timing information to display first and second test images, obtain second timing information to control a state of the variable polarization film based on the first timing information, alternately output, through the image output module, the first and second test images based on the first timing information, alternately change the variable polarization film to a first state transmitting light having first orientation or a second state transmitting light having second orientation based on the second timing information, and while outputting the first or second test image, obtain, through the illumination sensor, a first illumination value group, and determine whether to correct one of the first or second timing information based on the first illumination value group.

### CROSS-REFERENCE TO RELATED APPLICATION(S

This application is a bypass continuation of International Application No. PCT/KR2025/021108, filed on December 9, 2025, which is based on and claims priority to Korean Patent Application No. 10-2025-0011786, filed on January 24, 2025, in the Korean Intellectual Property Office, the disclosures of which are incorporated by reference herein in their entireties.

### BACKGROUND

### 1. Field

The disclosure relates to an electronic apparatus and a controlling method thereof, and more particularly, to an electronic apparatus that outputs an image providing a three-dimensional (3D) visual effect (i.e., a “3D effect”) through a variable polarization film, and a controlling method thereof.

### 2. Description of Related Art

A user can view a 3D image by wearing 3D glasses. A 3D image may be an image that is provided for visually experiencing a 3D stereoscopic effect. An electronic apparatus may provide a 3D image by using binocular disparity for providing a 3D stereoscopic effect to a user.

An operation of using binocular disparity may mean using a difference in the field of vision that is generated due to a difference in the respective physical locations of a left eye and a right eye of a person. A left eye image and a right eye image may be provided to a user for providing a 3D effect.

In order to ensure that a left eye image reaches only a left eye of a user, and a right eye image reaches only a right eye of a user, a user may wear passive 3D glasses. The 3D glasses may consist of a left lens part including a first polarization film such that only a left eye image passes through, and a right lens part including a second polarization film such that only a right eye image passes through.

Also, for making two types of polarization images, two electronic apparatuses in total, i.e., an electronic apparatus (e.g., a display projector or, simply, a “projector”) on which the first polarization film is attached, and an electronic apparatus (a projector) on which the second polarization film is attached may be used. However, it is difficult to precisely align images projected from each of the two electronic apparatuses (projectors) over a large screen or area into one image. Also, in the event an image is not precisely aligned, there is a problem that a 3D effect is not provided normally (i.e., the image may appear blurry, misaligned, or otherwise defective).

In this scenario, if a variable polarization film is used, each of a left eye image and a right eye image may be output as polarization in different directions with one electronic apparatus (a projector). The electronic apparatus may change a polarization property corresponding to the left eye image and a polarization property corresponding to the right eye image.

However, when the timing of alternately outputting a left eye image and a right eye image and the timing of changing polarization properties do not coincide (i.e., are not synchronized), there is a problem that a 3D effect is not provided normally.

In this scenario, there is a problem that the user wearing the 3D glasses feels dizzy, disoriented, nauseated, or otherwise unwell.

### SUMMARY

The disclosure was devised for improving the aforementioned problem, and the purpose of the disclosure is in providing an electronic apparatus that outputs two types of polarization images with one electronic apparatus (e.g., a display projector or, simply, a “projector”), and senses the ambient illumination by outputting an inner test image, and automatically performs correction related to the timing based on the sensed illumination, and a controlling method thereof.

According to an embodiment, an electronic apparatus includes memory storing instructions, at least one processor including processing circuitry, an image output module, a variable polarization film, and an illumination sensor, wherein the instructions, when executed by the at least one processor individually or collectively, cause the electronic apparatus to obtain first timing information for displaying a first test image and a second test image, obtain second timing information for controlling a change in the state of the variable polarization film based on the first timing information; alternately output, through the image output module, the first test image and the second test image based on the first timing information, alternately change the variable polarization film to a first state configured to transmit a light oriented in a first direction or a second state configured to transmit a light oriented in a second direction based on the second timing information, and while the first test image or the second test image is being output; obtain, through the illumination sensor, a first illumination value group including a plurality of illumination values , and determine whether to correct one of the first timing information or the second timing information based on the first illumination value group.

The first test image may be a left eye image configured to produce a 3D effect, and the second test image may be a right eye image configured to produce the 3D effect.

The first test image may include a background of a first color, and the second test image may include a background of a second color brighter than the first color.

The first state may be a state configured to transmit a light oriented in a first direction, and the second state may be a state configured to transmit a light oriented in a second direction different from the first direction.

The first state may be a state configured to transmit a light polarized along an x-axis, and the second state may be a state configured to transmit a light polarized along a y-axis.

The instructions, when executed by the at least one processor individually or collectively, may cause the electronic apparatus to, while the variable polarization film is controlled in the first state based on the second timing information; output, through the image output module, the first test image based on the first timing information, and while the variable polarization film is controlled in the second state based on the second timing information; output, through the image output module, the second test image based on the first timing information.

The instructions, when executed by the at least one processor individually or collectively, may cause the electronic apparatus to obtain a first representative value based on the first illumination value group, and based on the first representative value being smaller than a threshold value, determine the first timing information as first target timing, and determine the second timing information as second target timing; and output, through the image output module, a projection image based on the first target timing and the second target timing, and the first representative value may be one of a maximum value or an average value.

The instructions, when executed by the at least one processor individually or collectively, may cause the electronic apparatus to, based on the first representative value being greater than or equal to the threshold value, obtain delay information, obtain third timing information by updating the second timing information based on the delay information, and alternately change the variable polarization film to the first state or the second state based on the third timing information.

The instructions, when executed by the at least one processor individually or collectively, may cause the electronic apparatus to, while controlling the variable polarization film based on the third timing information, obtain, through the illumination sensor, a second illumination value group including a plurality of illumination values, obtain a second representative value based on the second illumination value group, and based on the second representative value being smaller than the threshold value, determine the first timing information as first target timing, and determine the third timing information as second target timing.

The illumination sensor may be a sensor that senses an illumination value based on a light that passes through an illumination polarization film configured to transmit a light oriented in the first direction.

According to an embodiment, a controlling method of an electronic apparatus including a variable polarization film, an illumination sensor and an image output module includes the steps of obtaining first timing information for displaying a first test image and a second test image, obtaining second timing information for controlling a change in the state of the variable polarization film based on the first timing information, alternately outputting, through the image output module, the first test image and the second test image based on the first timing information, alternately changing the variable polarization film to a first state configured to transmit a light oriented in a first direction or a second state configured to transmit a light oriented in a second direction based on the second timing information, and while the first test image or the second test image is being output, obtaining a first illumination value group including a plurality of illumination values through the illumination sensor, and determining whether to correct one of the first timing information or the second timing information based on the first illumination value group.

The first test image may be a left eye image configured to produce a 3D effect, and the second test image may be a right eye image configured to produce the 3D effect.

The first test image may include a background of a first color, and the second test image may include a background of a second color brighter than the first color.

The first state may be a state configured to transmit a light oriented in a first direction, and the second state may be a state configured to transmit a light oriented in a second direction different from the first direction.

The first state may be a state configured to transmit a light polarized along an x-axis, and the second state may be a state configured to transmit a light polarized along a y-axis.

In the step of outputting the first test image and the second test image, while the variable polarization film is controlled in the first state based on the second timing information, the first test image may be output through the image output module based on the first timing information, and while the variable polarization film is controlled in the second state based on the second timing information, the second test image may be output through the image output module based on the first timing information.

In the step of determining whether to correct, a first representative value may be obtained based on the first illumination value group, and based on the first representative value being smaller than a threshold value, the first timing information may be determined as first target timing, and the second timing information may be determined as second target timing, and the controlling method may include the step of outputting, through the image output module, a projection image based on the first target timing and the second target timing, and the first representative value may be one of a maximum value or an average value.

In the step of determining whether to correct, based on the first representative value being greater than or equal to the threshold value, delay information may be obtained; third timing information may be obtained by updating the second timing information based on the delay information; and the variable polarization film may be alternately changed to the first state or the second state based on the third timing information.

In the step of determining whether to correct, while controlling the variable polarization film based on the third timing information, a second illumination value group including a plurality of illumination values may be obtained through the illumination sensor, a second representative value may be obtained based on the second illumination value group, and based on the second representative value being smaller than the threshold value, the first timing information may be determined as first target timing, and the third timing information may be determined as second target timing.

The illumination sensor may be a sensor that senses an illumination value based on a light that passes through an illumination polarization film configured to transmit a light oriented in the first direction.

### BRIEF DESCRIPTION OF DRAWINGS

FIG. 1 is a diagram illustrating an operation of providing a 3D image according to an embodiment;

FIG. 2 is a block diagram illustrating an electronic apparatus according to an embodiment;

FIG. 3 is a block diagram illustrating a detailed configuration of the electronic apparatus in FIG. 2 according to an embodiment;

FIG. 4 is a diagram illustrating a polarization film according to an embodiment;

FIG. 5 is a diagram illustrating an electronic apparatus including an image output module and a variable polarization film according to an embodiment;

FIG. 6 is a diagram illustrating a polarization film and an illumination sensor according to an embodiment;

FIG. 7 is a diagram illustrating an illumination sensor including a polarization film according to an embodiment;

FIG. 8 is a diagram illustrating a 3D effect by a passive method that outputs two images as different devices according to an embodiment;

FIG. 9 is a diagram illustrating a 3D effect by an active method according to an embodiment;

FIG. 10 is a diagram illustrating a 3D effect by using a variable polarization film and polarization on an x axis according to an embodiment;

FIG. 11 is a diagram illustrating an example of providing a 3D effect by using a variable polarization film and polarization on a y axis according to an embodiment;

FIG. 12 is a diagram illustrating an example of providing a 3D effect by using polarization on an x axis in a plurality of variable polarization films according to an embodiment;

FIG. 13 is a diagram illustrating an example of providing a 3D effect by using polarization on a y axis in a plurality of variable polarization films according to an embodiment;

FIG. 14 is a diagram illustrating an operation of outputting an image through a display according to an embodiment;

FIG. 15 is a diagram illustrating an operation of outputting an image through a display according to an embodiment;

FIG. 16 is a diagram illustrating a test image according to an embodiment;

FIG. 17 is a diagram illustrating a situation wherein a test image is output normally according to an embodiment;

FIG. 18 is a diagram illustrating an illumination value that is obtained in a situation wherein a test image is output normally according to an embodiment;

FIG. 19 is a diagram illustrating a situation wherein a test image is output abnormally according to an embodiment;

FIG. 20 is a diagram illustrating an illumination value that is obtained in a situation wherein a test image is output abnormally according to an embodiment;

FIG. 21 is a diagram illustrating a state of a variable polarization film according to an embodiment;

FIG. 22 is a diagram illustrating an operation of providing a projection image by correcting timing according to an embodiment;

FIG. 23 is a diagram illustrating first timing information applied to an image output module and second timing information applied to a variable polarization film according to an embodiment;

FIG. 24 is a diagram illustrating an operation of providing a projection image and controlling a variable polarization film by correcting timing based on an illumination value group according to an embodiment;

FIG. 25 is a diagram illustrating an operation of outputting a test image according to an embodiment;

FIG. 26 is a diagram illustrating an operation of analyzing an illumination value according to an embodiment;

FIG. 27 is a diagram illustrating an operation of correcting timing according to an embodiment;

FIG. 28 is a diagram illustrating an operation of correcting timing according to an embodiment;

FIG. 29 is a diagram illustrating an operation of providing a projection image according to an embodiment; and

FIG. 30 is a diagram illustrating a controlling method of an electronic apparatus according to an embodiment.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g., elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g., a first element) is “operatively or communicatively coupled with/to” or “connected to” another element (e.g., a second element) should be interpreted to include both the case where the one element is directly coupled to the another element, and the case where the one element is coupled to the another element through still another element (e.g., a third element).

Also, singular expressions include plural expressions, unless plainly defined differently in the context. Further, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Further, a plurality of “modules” or “parts” may be integrated into at least one module and implemented as at least one processor, except “a module” or “a part” that needs to be implemented as specific hardware.

Also, in this specification, the term “user” may refer to a person who uses an electronic apparatus or an apparatus using an electronic apparatus (e.g., an artificial intelligence electronic apparatus).

Hereinafter, one or more embodiments of the disclosure will be described in more detail with reference to the accompanying drawings.

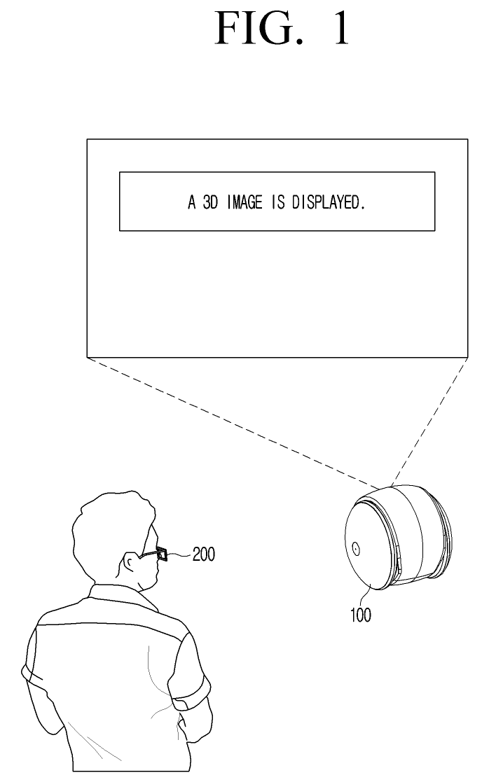

FIG. 1 is a diagram for illustrating an operation of providing a 3D image according to one or more embodiments.

Referring to FIG. 1, an electronic apparatus 100 may output a 3D image for providing a 3D effect. As a 3D image, a left eye image and a right eye image may be output. The electronic apparatus 100 may output the left eye image and the right eye image.

A user may wear 3D glasses 200. The user may view the output 3D image through the 3D glasses 200. The 3D glasses 200 may include a polarization film. The 3D glasses 200 may make a light pass through the polarization film in a specific direction (i.e., orientation).

If the light of the 3D image is received having an orientation in the specific direction imparted by the polarization film, the user may sense (i.e., see) the 3D effect by using binocular disparity.

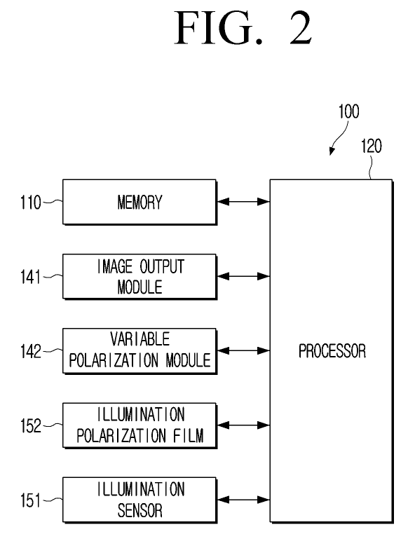

FIG. 2 is a block diagram illustrating the electronic apparatus 100 according to one or more embodiments.

Referring to FIG. 2, the electronic apparatus 100 may include at least one of memory 110 storing instructions, at least one processor 120 including processing circuitry, an image output module 141, a variable polarization film 142, or an illumination sensor 151.

The electronic apparatus 100 may be an apparatus that outputs an image. The at least one processor 120 may output an image through the image output module 141.

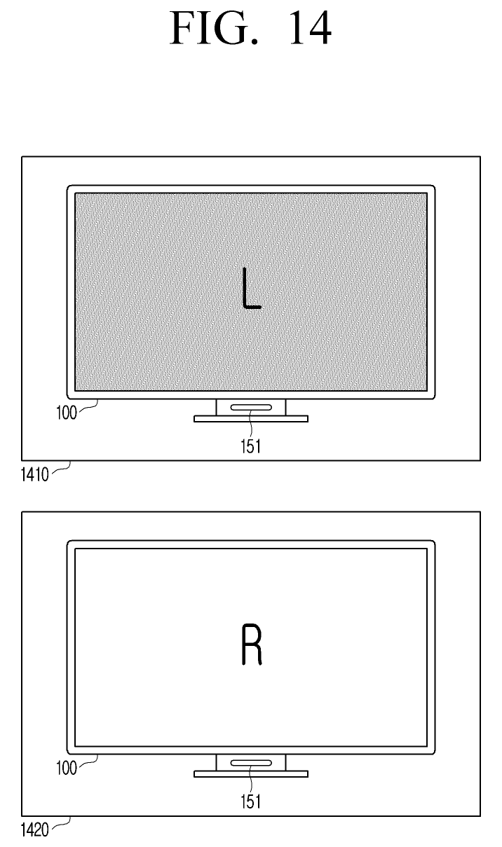

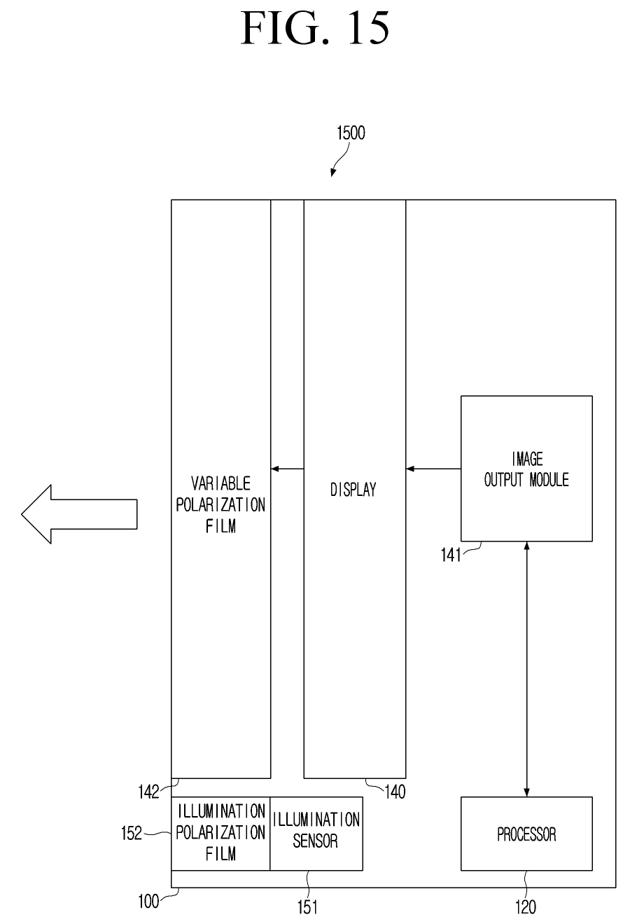

As an example, the image output module 141 may include a display 140. The at least one processor 120 may output an image through the display 140. Explanation in this regard will be described in FIG. 14 and FIG. 15.

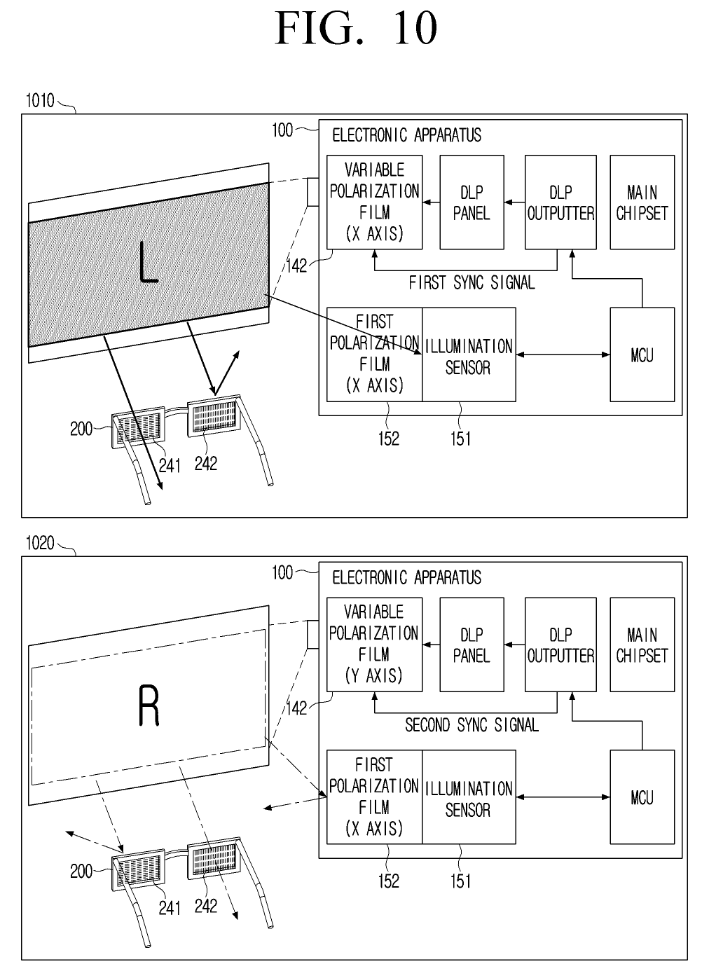

As an example, the image output module 141 may include a projection part. The at least one processor 120 may output an image through the projection part. Explanation in this regard will be described in FIG. 10 to FIG. 13.

The at least one processor 120 may output an image providing the 3D effect. The at least one processor 120 may alternately provide a left eye image and a right eye image for providing the 3D effect. The at least one processor 120 may output the left eye image and the right eye image by a predetermined cycle (or pattern).

In outputting the left eye image and the right eye image, the at least one processor 120 may control the variable polarization film 142. The variable polarization film 142 may be a film that controls an output light and/or image such that only a light in a specific direction thereof passes through. The variable polarization film 142 may be described as a variable polarization film, a variable polarization element, etc.

The variable polarization film 142 may also be described as a phase modulation polarization element.

The at least one processor 120 may simultaneously control the timing of changing an image and the timing of changing the state (or the mode) of the variable polarization film 142. The at least one processor 120 may match a specific image and a state of making specific polarization pass through.

The at least one processor 120 may obtain first timing information for displaying a first test image and a second test image. The first test image and the second test image may be images configured to produce the 3D effect.

As an example, the first test image may be a left eye image configured to produce the 3D effect, and the second test image may be a right eye image configured to produce the 3D effect.

As an example, the first test image may include a background of a first color. The second test image may include a background of a second color brighter than the first color.

The at least one processor 120 may obtain second timing information for controlling a change in the state of the variable polarization film 142 based on the first timing information.

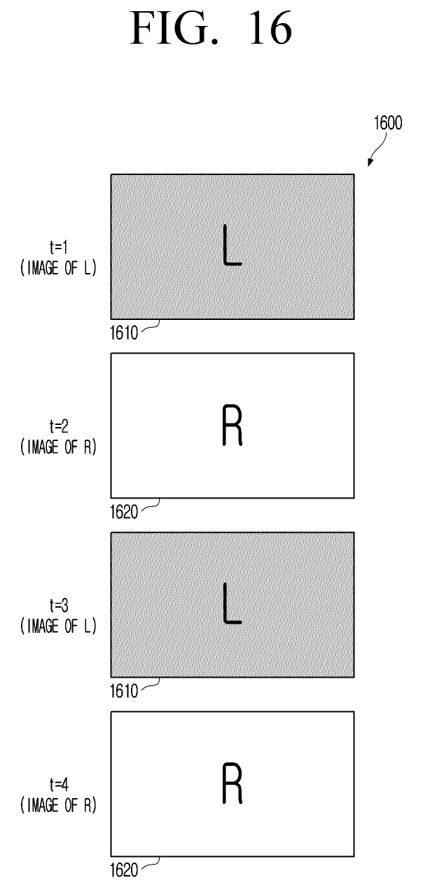

The at least one processor 120 may alternately output the first test image and the second test image based on the first timing information. The operation of alternately outputting may indicate that the first test image or the second test image is selectively output based on a predetermined cycle (or pattern). Explanation regarding the first test image and the second test image will be described in FIG. 16.

The at least one processor 120 may alternately change the variable polarization film 142 to a first state configured to transmit a light oriented in a first direction or a second state configured to transmit a light oriented in a second direction based on the second timing information.

As an example, the first state may be a state configured to transmit a light oriented in the first direction. The second state may be a state configured to transmit a light oriented in the second direction different from the first direction.

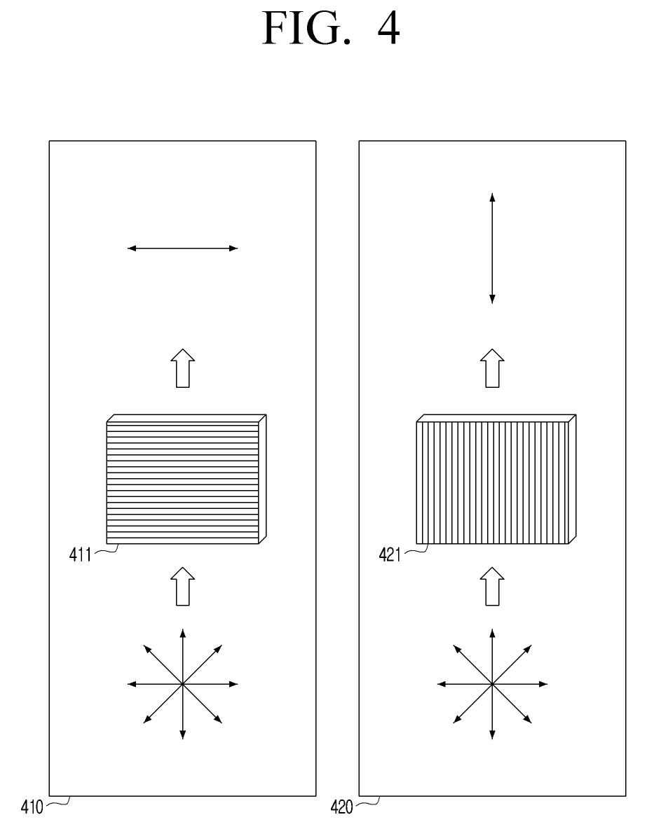

As an example, the first state may be a state configured to transmit a light polarized along an x-axis. The second state may be a state configured to transmit a light polarized along a y-axis. Explanation regarding polarization on the x-axis and polarization on the y-axis will be described in FIG. 4.

The first state and the second state may or may not be applied to only one physical component. The first state and the second state may indicate physical properties configured to transmit only light oriented in a specific direction.

The first state may be described as a first phase, and the second state may be described as a second phase. An operation of changing from the first state to the second state may be described as an operation of modulating from the first phase to the second phase.

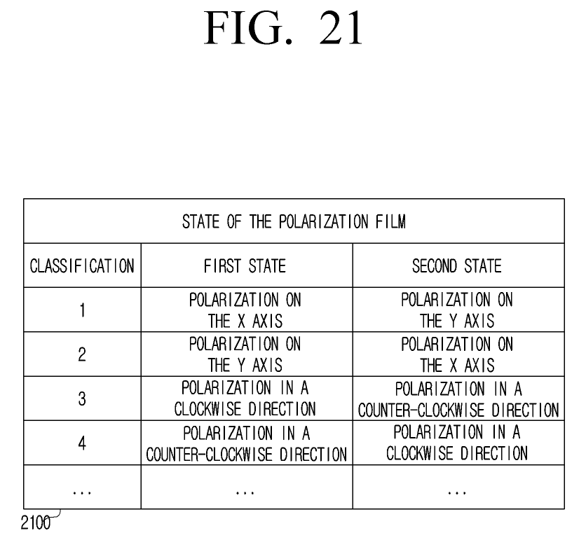

Meanwhile, polarization on the x-axis and polarization on the y-axis are merely an example, and various polarization properties may be applied. Explanation in this regard will be described in FIG. 21.

While the first test image or the second image is being output, the at least one processor 120 may obtain a first illumination value group including a plurality of illumination values through the illumination sensor 151. The at least one processor 120 may correct one of the first timing information or the second timing information based on the first illumination value group.

While the variable polarization film 142 is controlled in the first state based on the second timing information, the at least one processor 120 may output the first test image based on the first timing information.

While the variable polarization film 142 is controlled in the second state based on the second timing information, the at least one processor 120 may output the second test image based on the first timing information.

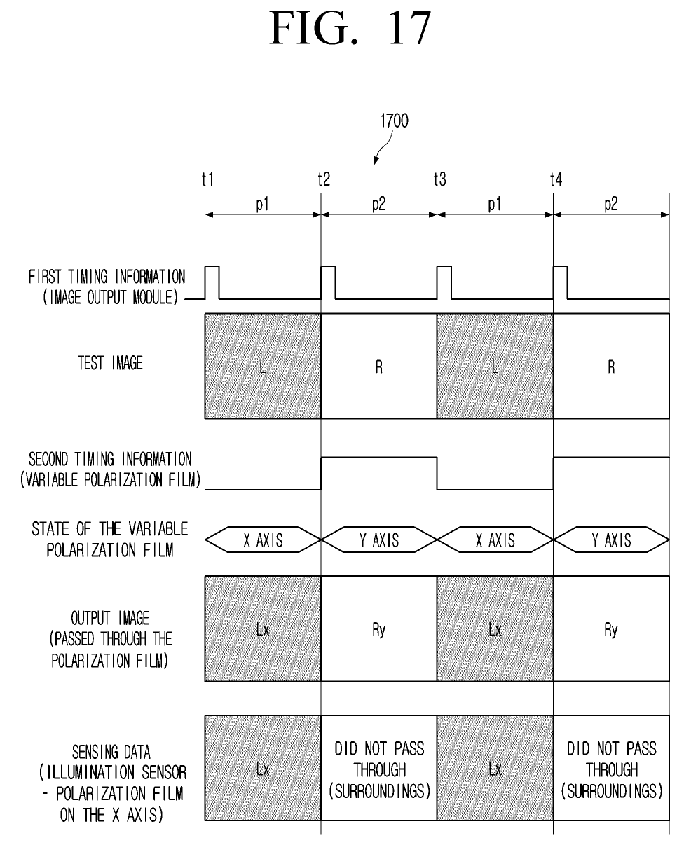

Explanation in this regard will be described in FIG. 10 and FIG. 17.

The at least one processor 120 may obtain a first representative value based on the first illumination value group. If the first representative value is smaller than a threshold value, the at least one processor 120 may determine the first timing information as first target timing, and determine the second timing information as second target timing. The first representative value may be one of a maximum value or an average value.

The first target timing may indicate timing information used for outputting a projection image (a left eye image and a right eye image). The first target timing may be described as first target timing information or first final timing information.

The second target timing may indicate timing information used for controlling the variable polarization film 142. The second target timing may be described as second target timing information or second final timing information.

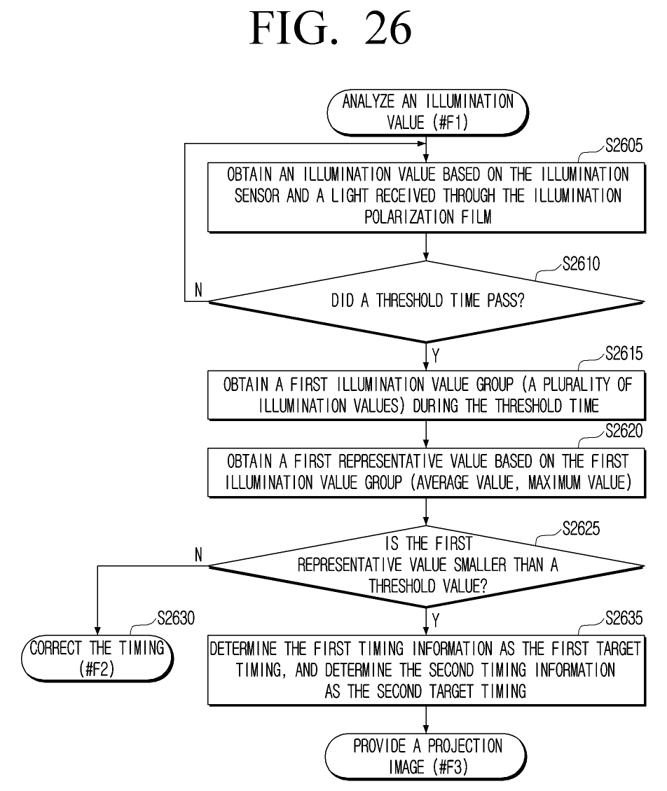

Explanation in this regard will be described in FIG. 26.

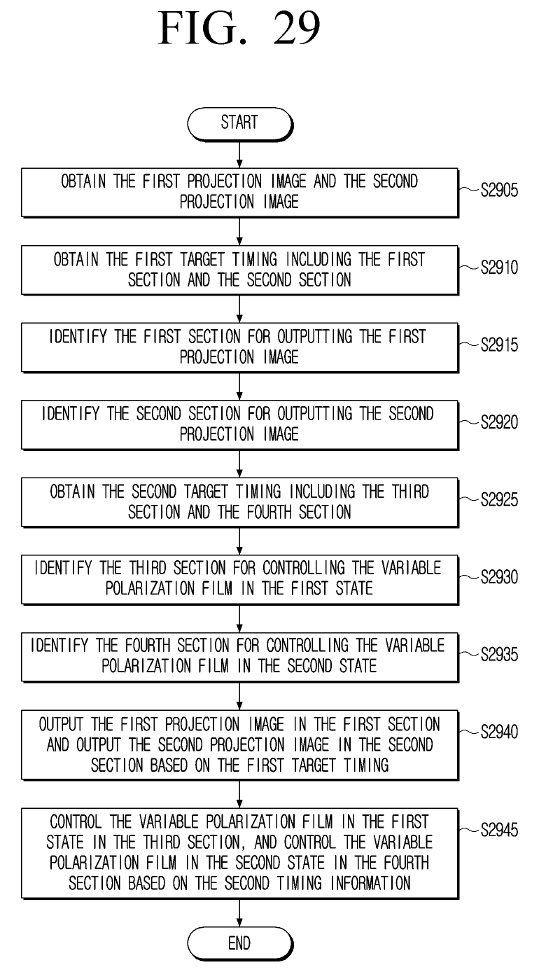

The at least one processor 120 may make a projection image output based on the first target timing and the second target timing. Explanation in this regard will be described in FIG. 29.

If the first representative value is greater than or equal to the threshold value, the at least one processor 120 may obtain delay information. The at least one processor 120 may obtain third timing information by updating the second timing information based on the delay information. The at least one processor 120 may alternately change the variable polarization 142 to the first state or the second state based on the third timing information.

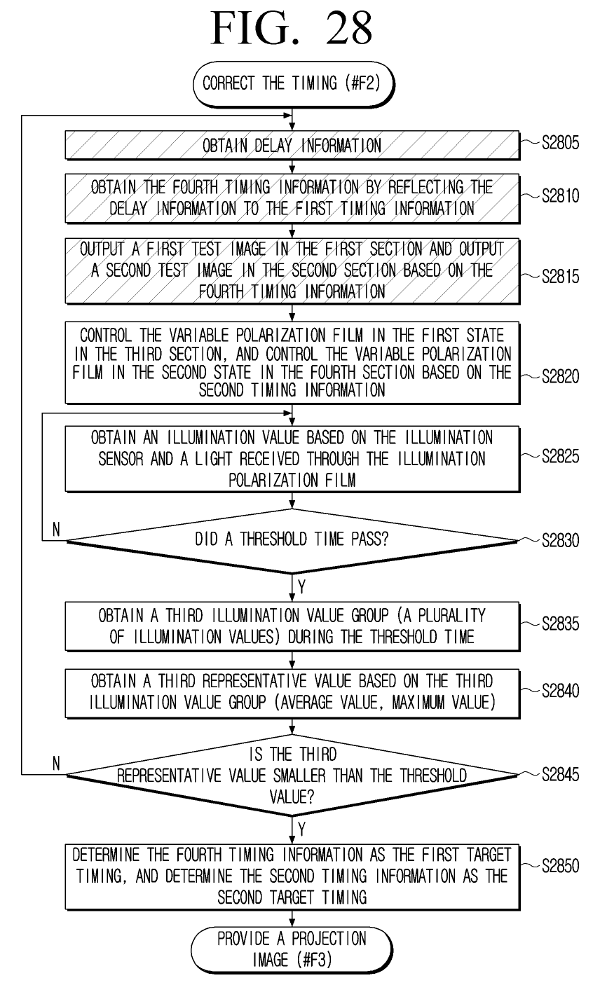

The delay information may include information for delaying timing. An operation of applying the delay information to the first timing information but not the second timing information will be described in FIG. 28.

While the at least one processor 120 is controlling the variable polarization film 142 based on the third timing information, the at least one processor 120 may obtain a second illumination value group including a plurality of illumination values through the illumination sensor 151. The at least one processor 120 may obtain a second representative value based on the second illumination value group. If the second representative value is smaller than a threshold value, the at least one processor 120 may determine the first timing information as the first target timing, and determine the third timing information as the second target timing.

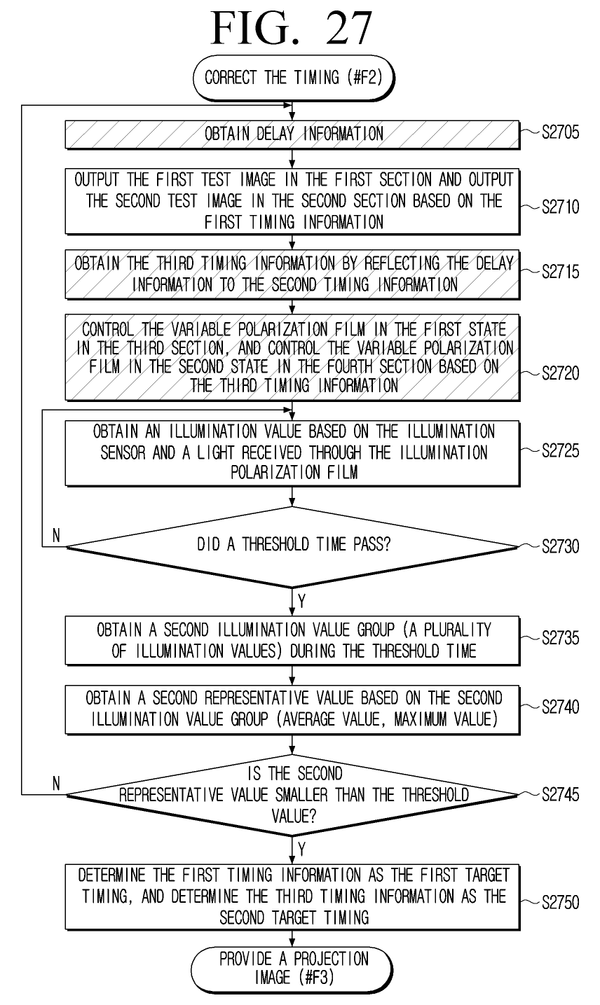

Explanation in this regard will be described in FIG. 27.

The illumination sensor 151 may be a sensor that senses an illumination value based on a light that passes through an illumination polarization film 152 configured to transmit a light oriented in the first direction.

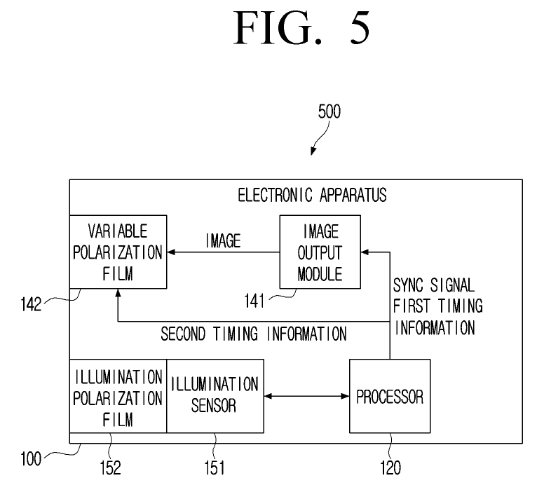

Explanation related to the illumination polarization film 152 will be described in FIG. 5 to FIG. 7, and FIG. 10 to FIG. 13.

The electronic apparatus 100 may output the first test image as polarization in the first direction through the variable polarization film 142. The at least one processor 120 may absorb (i.e., sense or detect) only polarization in the first direction through the illumination polarization film 152. The at least one processor 120 may obtain an illumination value by sensing only polarization in the first direction corresponding to the first test image through the illumination sensor 151.

The electronic apparatus 100 may compare an illumination value expected through the background color of the first test image and the sensed illumination value. The at least one processor 120 may determine whether the timing of converting the image and the timing of converting the state of the variable polarization film 142 coincide based on the comparison result.

If the timings coincide, an operation of correcting the timing may not be needed. However, if the timings do not coincide, the electronic apparatus 100 may make the timing of converting the image and the timing of converting the state of the variable polarization film 142 coincide through an operation of correcting the timing.

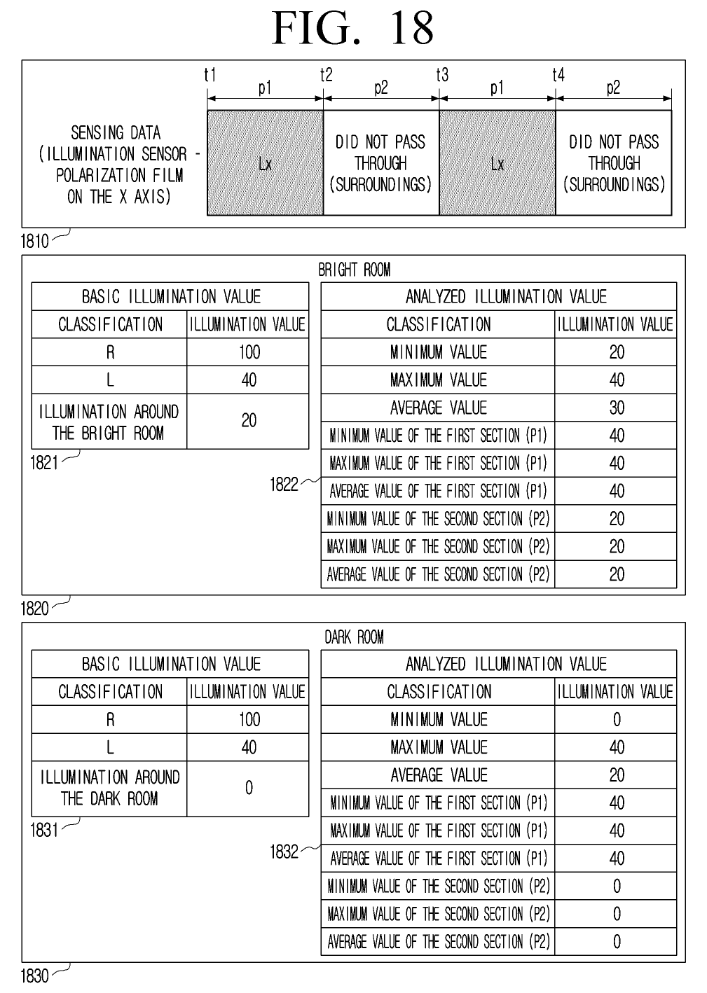

Illumination analysis performed in a normal state will be described in FIG. 17 and FIG. 18.

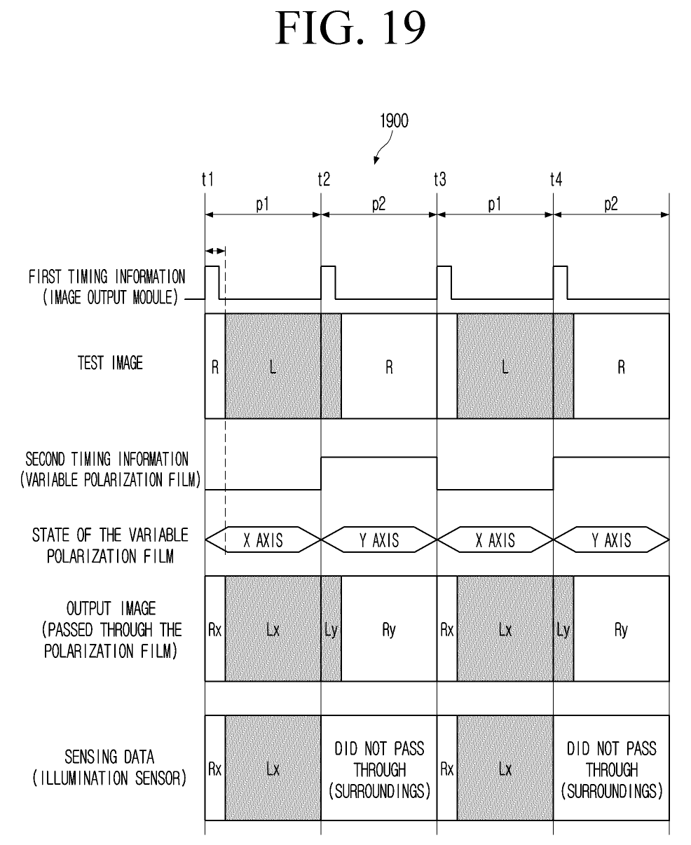

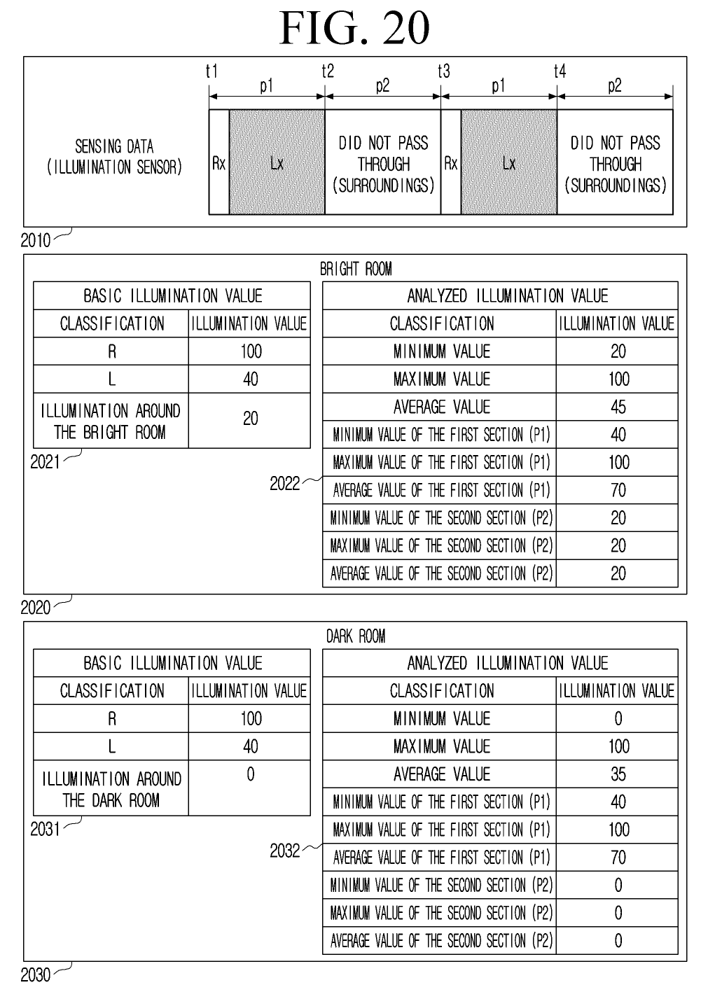

Illumination analysis performed in an abnormal state will be described in FIG. 19 and FIG. 20.

The electronic apparatus 100 may automatically make the timing of converting the image and the timing of converting the state of the variable polarization film 142 coincide without the user’s manual setting.

As an example, the electronic apparatus 100 may arrange dummy glass that has the same optical distance as the variable polarization film 142. The dummy glass may be film that does not have a polarization property. The electronic apparatus 100 may output a general image which is not a 3D image. In the case of outputting a 3D image, the electronic apparatus 100 may use the variable polarization film 142. In the case of outputting a general image, the electronic apparatus 100 may use the dummy glass instead of the variable polarization film 142. The electronic apparatus 100 may switch the variable polarization film 142 or the dummy glass based on an image type of a subject to be output. In the case of using the dummy glass, a problem that brightness is reduced or a problem of heat generation can be prevented.

As an example, the electronic apparatus 100 may include a cooling module for cooling in implementing the variable polarization film 142. The cooling module may include a fan. The fan may be arranged within a threshold distance of the variable polarization film 142. The cooling module may generate a flow of air by operating the fan. The temperature of the variable polarization film 142 can be controlled through the flow of air generated by the fan.

As an example, the variable polarization film 142 may include a first polarization film and a second polarization film that are provided by a slide method. The first polarization film may be a film that is configured to transmit only a light oriented in the first direction. The second polarization film may be a film that is configured to transmit only a light oriented in the second direction. The first polarization film and the second polarization film may be moved by the slide method based on the first timing information. In case the first test image is output, the electronic apparatus 100 may move the first polarization film to be aligned with the direction in which the first test image is output by the slide method. In case the second test image is output, the electronic apparatus 100 may move the second polarization film to be aligned with the direction in which the second test image is output by the slide method.

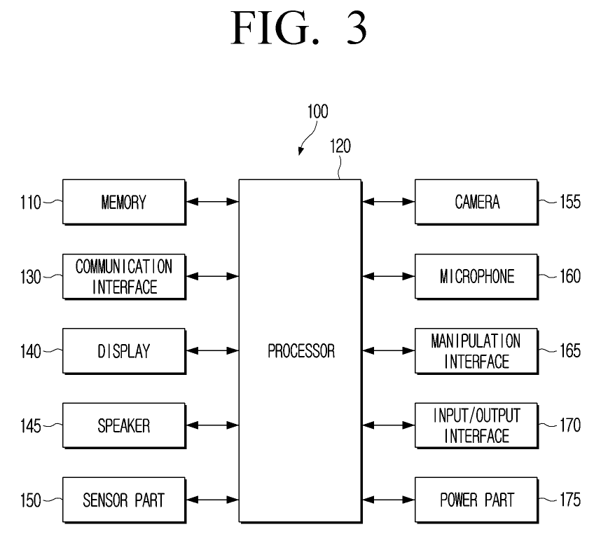

FIG. 3 is a block diagram for illustrating a detailed configuration of the electronic apparatus 100 in FIG. 2 according to one or more embodiments.

Referring to FIG. 3, the electronic apparatus 100 may include at least one of memory 110, at least one processor 120, a communication interface 130, a display 140, a speaker 145, a sensor part 150, a camera 155, a microphone 160, a manipulation interface 165, an input/output interface 170, or a power part 175.

The memory 110 may be implemented as internal memory such as ROM (e.g., electrically erasable programmable read-only memory (EEPROM)), RAM, etc. included in the at least one processor 120, or implemented as memory separate from the at least one processor 120. The memory 110 may be implemented in the form of memory embedded in the electronic apparatus 100, or implemented in the form of memory that can be attached to or detached from the electronic apparatus 100 according to the usage of stored data. For example, in the case of data for operating the electronic apparatus 100, the data may be stored in memory embedded in the electronic apparatus 100, and in the case of data for an extended function of the electronic apparatus 100, the data may be stored in memory that can be attached to or detached from the electronic apparatus 100.

In the case of memory embedded in the electronic apparatus 100, the memory may be implemented as at least one of volatile memory (e.g., dynamic RAM (DRAM), static RAM (SRAM), or synchronous dynamic RAM (SDRAM), etc.) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)). Also, in the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

The memory 110 may store at least one instruction. The at least one processor 120 may perform various operations based on the instructions stored in the memory 110.

The at least one processor 120 may perform overall control operations of the electronic apparatus 100. The at least one processor 120 may perform a function of controlling the overall operations of the electronic apparatus 100.

The at least one processor 120 may be implemented as a digital signal processor (DSP) processing digital signals, a microprocessor, and a time controller (TCON). However, the disclosure is not limited thereto, and the at least one processor 120 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the at least one processor 120 may be implemented as a system on chip (SoC) having a processing algorithm stored therein or large scale integration (LSI), or in the form of a field programmable gate array (FPGA). The at least one processor 120 may perform various functions by executing computer executable instructions stored in the memory.

The communication interface 130 is a component that performs communication with various types of external devices according to various types of communication methods. The communication interface 130 may include a wireless communication module and/or a wired communication module. Each communication module may be implemented in a form of at least one hardware chip.

A wireless communication module may be a module that communicates with an external device wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key, etc. is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external device via wire. For example, a wired communication module may include at least one of a local area network (LAN) module, an Ethernet module, a pair cable, a coaxial cable, an optical fiber cable, or an ultra wide-band (UWB) module.

According to one or more embodiments, the communication interface 130 may use the same communication module (e.g., a Wi-Fi module) for communicating with an external device such as a remote control device and an external server.

According to one or more embodiments, the communication interface 130 may use different communication modules for communicating with an external device such as a remote control device and an external server. For example, the communication interface 130 may use at least one of an Ethernet module or a Wi-Fi module for communicating with an external server, or use a Bluetooth module for communicating with an external device such as a remote control device. However, this is merely an example, and the communication interface 130 may use at least one communication module among various communication modules in the case of communicating with a plurality of external devices or external servers.

The display 140 may be implemented as displays in various forms such as a liquid crystal display (LCD), an organic light emitting diodes (OLED) display, a plasma display panel (PDP), a digital micromirror device (DMD), etc. Inside the display 140, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. Also, the display 140 may be implemented as a touch screen combined with a touch sensor, a flexible display, a three-dimensional (3D) display, etc. The display 140 according to one or more embodiments of the disclosure may include not only a display panel outputting images, but also a bezel housing the display panel. In particular, a bezel according to one or more embodiments of the disclosure may include a touch sensor for detecting user interactions.

The display 140 may display a screen. The screen may include an image, a video, a text, etc. Also, the screen may include a content screen, an application execution screen, a web browser screen, a graphic user interface (GUI) screen, etc.

The speaker 145 may be a component that outputs not only various kinds of audio data but also various kinds of notification sounds or voice messages, etc.

The sensor part 150 may collect data indicating the ambient environment or a state related to the electronic apparatus 100. The sensor part 150 may include at least one sensor. The sensor part 150 may include a sensor that senses the outside environment of the electronic apparatus 100. For instance, the sensor part 150 may be configured to sense or detect one or more of brightness, electromagnetic radiation, temperature, motion, acceleration, distance, image contrast, resolution, color of ambient, incident, or reflected light, etc. The sensor part 150 may include a sensor that senses the inner state of the electronic apparatus 100. Sensing data collected through the sensor may be transmitted to one of the memory 110, the at least one processor 120, or the communication interface 130 of the electronic apparatus 100.

The camera 155 is a component for generating a photographed image by photographing a subject, and a photographed image is a concept including both of a moving image and a still image. The camera 155 may obtain an image for at least one external device, and may be implemented as a camera, a lens, an infrared sensor, etc.

The camera 155 may include a lens and an image sensor. As types of a lens, there are general generic-purpose lenses, wide-angle lenses, zoom lenses, etc., and the type may be determined according to the type, the characteristic, the use environment, etc. of the electronic apparatus 100. As an image sensor, a complementary metal oxide semiconductor (CMOS) and a charge coupled device (CCD), etc. may be used.

The microphone 160 is a component for receiving input of a user voice or other sounds, and converting them into audio data. The microphone 160 may receive a user’s voice in an activated state. For example, the microphone 160 may be formed as an integrated type on the upper side or the front surface direction, the side surface direction, etc. of the electronic apparatus 100. The microphone 160 may include various components such as a microphone collecting a user voice in an analog form, an amplifier circuit (i.e., “amp”) amplifying the collected user voice, an A/D conversion circuit that samples the amplified user voice and converts the user voice into a digital signal, a filter circuit that removes noise components from the converted digital signal, etc.

The manipulation interface 165 may be implemented as a device like a button, a touch pad, a mouse, and a keyboard, or as a touch screen that can perform both of the aforementioned display function and a manipulation input function. A button may be various types of buttons such as a mechanical button, a touch pad, a wheel, etc. formed in any areas such as the front surface part or the side surface part, the rear surface part, etc. of the exterior of the main body of the electronic apparatus 100.

The input/output interface 170 may be any one interface among a high definition multimedia interface (HDMI), a mobile high-definition link (MHL), a universal serial bus (USB), a display port (DP), a Thunderbolt, a video graphics array (VGA) port, an RGB port, a D-subminiature (D-SUB), and a digital visual interface (DVI). The input/output interface 170 may input or output at least one of an audio signal or a video signal. Depending on implementation examples, the input/output interface 170 may include a port inputting and outputting only audio signals and a port inputting and outputting only video signals as separate ports, or it may be implemented as one port that inputs and outputs both audio signals and video signals. The electronic apparatus 100 may transmit at least one of an audio signal or a video signal to an external device (e.g., an external display device or an external speaker) through the input/output interface 170. An output port included in the input/output interface 170 may be connected with an external device, and the electronic apparatus 100 may transmit at least one of an audio signal or a video signal to the external device through the output port.

The input/output interface 170 may be connected to the communication interface. The input/output interface 170 may transmit information received from an external device to the communication interface, or transmit information received through the communication interface to the external device.

The power part 175 may generate, convert, or supply power necessary for the electronic apparatus 100. The power part 175 may generate a supply voltage or a supply current by using a power supply. The power supply generated in the power part 175 may be supplied to various components included in the electronic apparatus 100.

FIG. 4 is a diagram for illustrating a polarization film according to one or more embodiments.

Referring to the embodiment 410 in FIG. 4, in the event lights having a plurality of directivities or orientations pass through a polarization film on the x-axis 411, only a light having a directivity or orientation in the x-axis may be output through the polarization film on the x-axis 411.

Referring to the embodiment 420 in FIG. 4, in the event lights having a plurality of directivities or orientations pass through a polarization film on the y-axis 421, only a light having a directivity or orientation in the y-axis may be output through the polarization film on the y-axis 421.

FIG. 5 is a diagram for illustrating the electronic apparatus 100 including an image output module 141 and a variable polarization film 142 according to one or more embodiments.

Referring to the embodiment 500 in FIG. 5, the electronic apparatus 100 may include at least one of at least one processor 120, an image output module 141, a variable polarization film 142, an illumination polarization film 152, or an illumination sensor 151.

The electronic apparatus 100 may control the image output module 141 by operating the at least one processor 120. The image output module 141 may output an image to the outside of the electronic apparatus 100. The image output by the image output module 141 may be output to the outside of the electronic apparatus 100 through the variable polarization film 142.

The electronic apparatus 100 may control the illumination sensor 151 through the at least one processor 120. The electronic apparatus 100 may activate the illumination sensor 151. The electronic apparatus 100 may include the illumination sensor 151 that receives the illumination outside the electronic apparatus 100 through the illumination polarization film 152. The illumination outside the electronic apparatus 100 may be received by the illumination sensor 151 through the illumination polarization film 152.

The electronic apparatus 100 may control the timing of the image output module 141 or the variable polarization film 142 based on the illumination sensed by the illumination sensor 151.

The electronic apparatus 100 may transmit the first timing information to the image output module 141. The image output module 141 may output the first test image and the second test image based on the first timing information.

The electronic apparatus 100 may transmit the second timing information to the variable polarization film 142. The variable polarization film 142 may control the state of the variable polarization film 142 to the first state or the second state based on the second timing information.

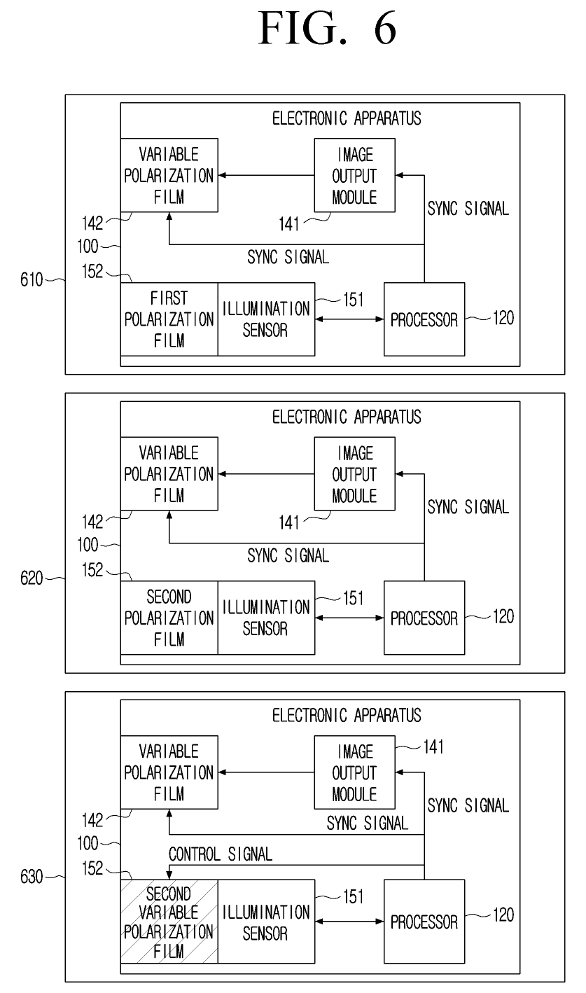

FIG. 6 is a diagram for illustrating a polarization film and an illumination sensor according to one or more embodiments.

The embodiments 610, 620, and 630 in FIG. 6 may indicate the electronic apparatus 100 wherein the illumination polarization film 152 and the illumination sensor 151 are separated. The at least one processor 120, the image output module 141, the variable polarization film 142, the illumination polarization film 152, and the illumination sensor 151 described in FIG. 5 may also be applied to FIG. 6. Accordingly, overlapping and/or redundant explanation(s) may be omitted.

The illumination polarization film 152 may be arranged farther outside of the electronic apparatus 100 than the illumination sensor 151. An external light of the electronic apparatus 100 may be received by the illumination sensor 151 through the illumination polarization film 152.

Referring to the embodiment 610 in FIG. 6, the illumination polarization film 152 may be implemented as a first polarization film. The first polarization film may indicate a polarization film in the first state. The first polarization film in the first state may be configured to transmit a light oriented in the first direction. The first state may indicate a structure that is configured to selectively transmit a light based on a specific vibration direction or a specific component. Also, the first state may indicate an optical property that selectively transmits a light based on a specific vibration direction or a specific component. The electronic apparatus 100 may control the image output module 141 and the variable polarization film 142 based on a synchronization (i.e., “sync”) signal. The sync signal may indicate timing information or target timing.

As an example, the first state may be one of a state configured to transmit a light having a directivity or orientation in or along the x-axis or a state configured to transmit a light having a clockwise directivity or orientation.

Referring to the embodiment 620 in FIG. 6, the illumination polarization film 152 may be implemented as a second polarization film. The second polarization film may indicate a polarization film in the second state. The second polarization film in the second state may be configured to transmit a light oriented in the second direction. The second state may indicate a structure that is configured to selectively transmit a light based on a specific vibration direction or a specific component. Also, the second state may indicate an optical property that selectively transmits a light based on a specific vibration direction or a specific component. The electronic apparatus 100 may control the image output module 141 and the variable polarization film 142 based on a sync signal. The sync signal may indicate timing information or target timing.

As an example, the second state may be one of a state configured to transmit a light having a directivity or orientation in the y-axis or a state configured to transmit a light having a clockwise directivity or orientation pass through.

Referring to the embodiment 630 in FIG. 6, the illumination polarization film 152 may be implemented as a second variable polarization film. The variable polarization film 142 may also be described as a first variable polarization film. The electronic apparatus 100 may control the state of the illumination polarization film 152 according to the user setting. In the case of wanting to control the illumination polarization film 152 in the first state, the electronic apparatus 100 may transmit a control signal for controlling in the first state to the illumination polarization film 152. In the case of wanting to control the illumination polarization film 152 in the second state, the electronic apparatus 100 may transmit a control signal for controlling in the second state to the illumination polarization film 152. The electronic apparatus 100 may control the image output module 141 and the variable polarization film 142 based on a sync signal. The sync signal may indicate timing information or target timing. Unlike the variable polarization film 142, the state of the illumination polarization film 152 may not need to be repeatedly changed according to a specific cycle.

In FIG. 6, one or more embodiments wherein the illumination polarization film 152 is distinguished from the illumination sensor 151 was described. However, depending on implementation examples, the illumination polarization film 152 may be included in the illumination sensor 151.

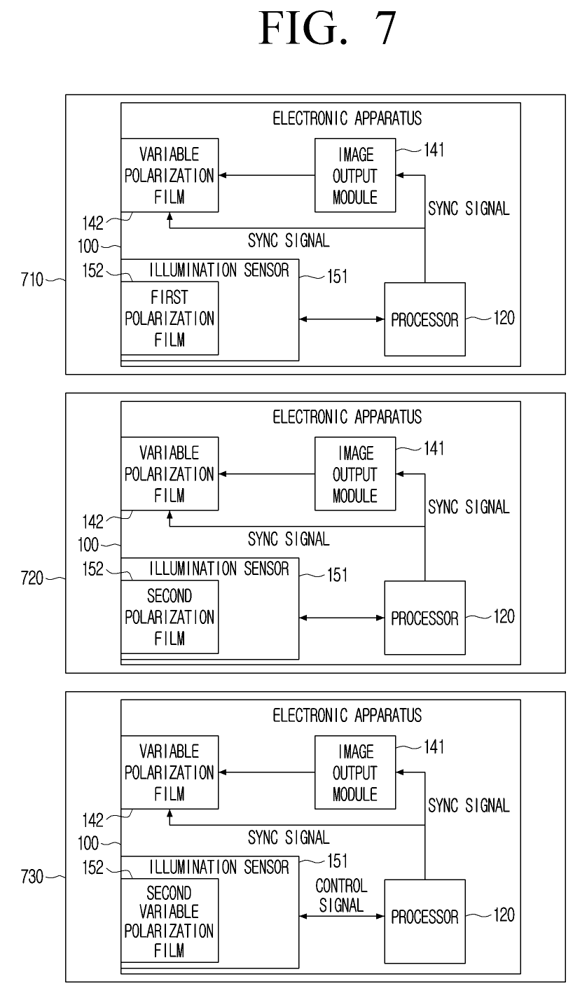

FIG. 7 is a diagram for illustrating the illumination sensor 151 including a polarization film according to one or more embodiments.

The embodiments 710, 720, and 730 in FIG. 7 may correspond to the embodiments 610, 620, and 630 in FIG. 6. Accordingly, overlapping explanation will be omitted.

The illumination polarization film 152 may be arranged to be included in the illumination sensor 151. The illumination polarization film 152 may be arranged to contact the surface of the illumination sensor 151. The illumination polarization film 152 may be arranged in an external direction of the electronic apparatus 100 on the inside of the illumination sensor 151. The electronic apparatus 100 may directly transmit a control signal for controlling the illumination polarization film 152 to the illumination sensor 151. The illumination sensor 151 may transmit the control signal to the illumination polarization film 152. The illumination polarization film 152 may control its own state based on the control signal.

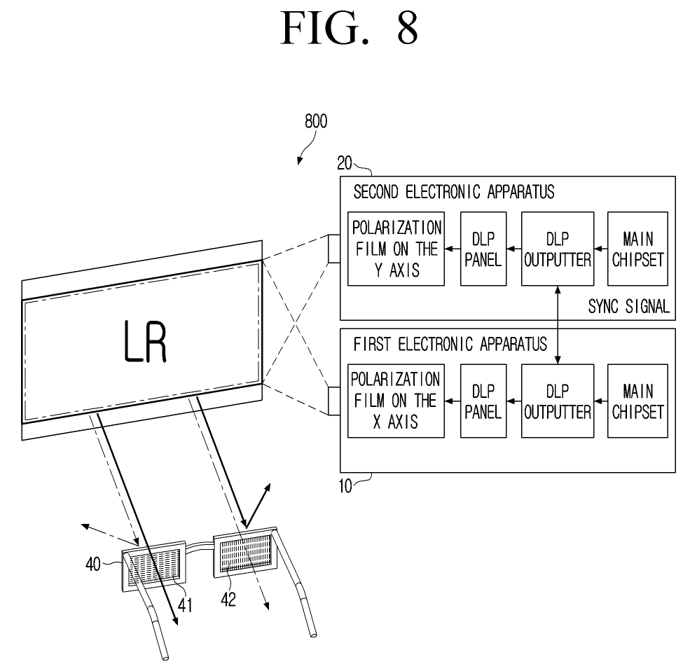

FIG. 8 is a diagram for illustrating a 3D effect by a passive method that outputs two images as different devices according to one or more embodiments.

Referring to the embodiment 800 in FIG. 8, the first electronic apparatus 10 may output a left eye image. The second electronic apparatus 20 may output a right eye image.

The first electronic apparatus 10 and the second electronic apparatus 20 may commonly include a main chipset, a digital light processing (DLP) outputter, and a DLP panel.

The first electronic apparatus 10 may include a polarization film on the x-axis. The first electronic apparatus 10 may output a left eye image through the DLP outputter. The left eye image may be output to the outside through the DLP panel and the polarization film on the x-axis.

The second electronic apparatus 20 may include a polarization film on the y-axis. The second electronic apparatus 20 may output a right eye image through the DLP outputter. The right eye image may be output to the outside through the DLP panel and the polarization film on the y-axis.

The user may wear 3D glasses 40. A left light polarization part 41 of the 3D glasses 40 may be a part for polarization on the x-axis, and a right light polarization part 42 of the 3D glasses 40 may be a part for polarization on the y-axis.

The left light polarization part 41 may transmit the left eye image output from the first electronic apparatus 10. However, the left light polarization part 41 may not transmit the right eye image output from the second electronic apparatus 20.

The right light polarization part 42 may not transmit the left eye image output from the first electronic apparatus 10. However, the right light polarization part 42 may transmit the right eye image output from the second electronic apparatus 20 .

The user can experience a 3D effect by wearing the 3D glasses 40 including the left light polarization part 41 and the right light polarization part 42.

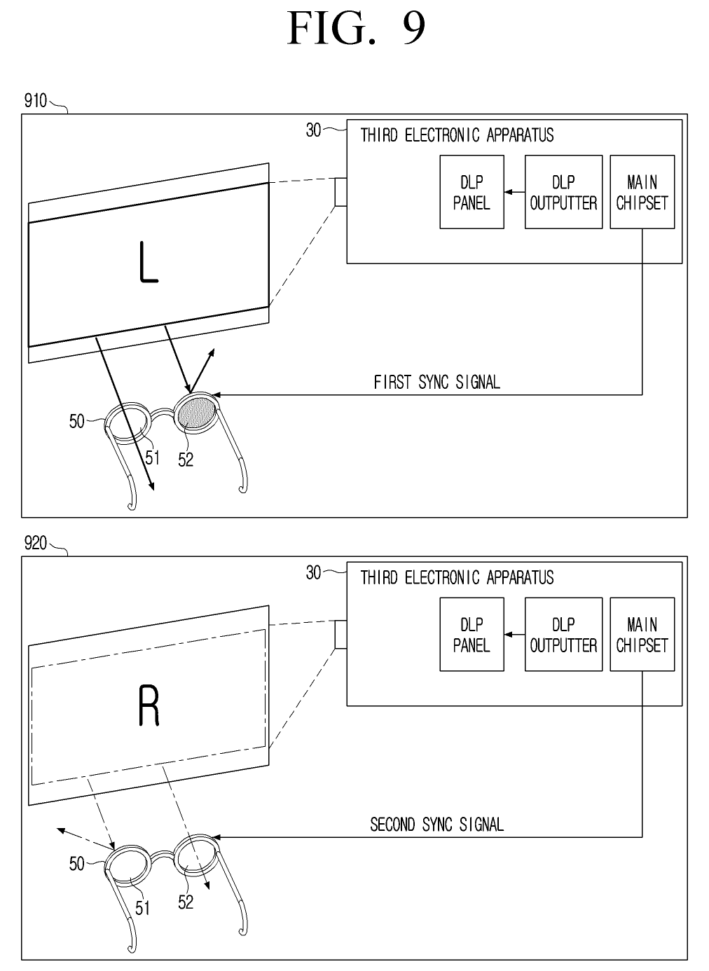

FIG. 9 is a diagram for illustrating a 3D effect by an active method according to one or more embodiments.

Referring to the embodiments 910 and 920 in FIG. 9, the third electronic apparatus 30 may include at least one of a main chipset, a DLP outputter, or a DLP panel. Explanation regarding the main chipset, the DLP outputter, and the DLP panel was described in FIG. 8. Accordingly, overlapping explanation will be omitted.

Referring to the embodiment 910 in FIG. 9, the third electronic apparatus 30 may output a left eye image. In case a left eye image is output, the electronic apparatus 100 may transmit a first sync signal corresponding to the left eye image to the 3D glasses 50. The 3D glasses 50 may be a device for determining whether an image passes through the left light polarization part 51 or the right light polarization part 52. The 3D glasses 50 may open the left light polarization part 51 and block the right light polarization part 52 based on the first sync signal. The 3D glasses 50 may transmit the left eye image output based on the first sync signal the left light polarization part 51. The right light polarization part 52 may not transmit the left eye image.

Referring to the embodiment 920 in FIG. 9, the third electronic apparatus 30 may output a right eye image. In case a right eye image is output, the electronic apparatus 100 may transmit a second sync signal corresponding to the right eye image to the 3D glasses 50. The 3D glasses 50 may be a device configured to determine whether an image passes through the left light polarization part 51 or the right light polarization part 52. The 3D glasses 50 may block the left light polarization part 51 and open the right light polarization part 52 based on the second sync signal. The 3D glasses 50 may transmit the right eye image output based on the second sync signal the right light polarization part 52. The left light polarization part 51 may not transmit the right eye image.

FIG. 10 to FIG. 14 explain an operation of correcting timing by outputting a test image.

A test image may include a first test image and a second test image. The first test image may be a left eye image, and the second test image may be a right eye image. The first test image (the left eye image) may include a relatively darker color (compared to the second test image). The second test image (the right eye image) may include a relatively brighter color (compared to the first test image). In the explanation below, the first test image will be described as a left eye image, and the second test image will be described as a right eye image.

As an example, the left eye image may include a black background. The right eye image may include a white background. If the left eye image with a black background is displayed, the ambient illumination may be lower than a case wherein the right eye image is displayed. If the right eye image with a white background is displayed, the ambient illumination may be higher than a case wherein the left eye image is displayed.

The electronic apparatus 100 may include at least one processor 120. As an example, the at least one processor 120 may include at least one of a main chipset or an MCU.

The electronic apparatus 100 may include an image output module 141. As an example, the image output module 141 may include at least one of a DLP outputter or a DLP panel. The DLP outputter may output an image to the DLP panel. The image output through the DLP panel may be output to the outside through the variable polarization film 142. Based on the state of the variable polarization film 142, only a light having a specific directivity or orientation may . The MCU may output a left eye image and a right eye image by controlling the DLP outputter. The DLP outputter may alternately output the left eye image and the right eye image.

FIG. 10 is a diagram for illustrating a 3D effect by using polarization on an x-axis according to one or more embodiments.

Referring to FIG. 10, the illumination polarization film 152 may be implemented as a first polarization film. The first polarization film may indicate a polarization film in a first state. The first polarization film in the first state may transmit only a light in a first direction .

Referring to the embodiment 1010 in FIG. 10, the DLP outputter may output a left eye image. The output left eye image may be output through the DLP panel and the variable polarization film 142.

The DLP outputter may transmit a first sync signal for controlling the variable polarization film 142 to a polarization state of the left eye image on the x-axis to the variable polarization film 142. The variable polarization film 142 may operate in the polarization state on the x-axis based on the first sync signal.

The user may wear 3D glasses 200. The 3D glasses 200 may include a left light polarization part 241 and a right light polarization part 242. The left light polarization part 241 may include a film in a first state (a state wherein only a light oriented in a first direction passes through). The right light polarization part 242 may include a film in a second state (a state wherein only a light oriented in a second direction passes through).

As an example, the left light polarization part 241 may be a light polarization part in a polarization state on the x-axis. As an example, the right light polarization part 242 may be a light polarization part in a polarization state on the y-axis.

The left eye image may be an image that was output via the variable polarization film 142 in the polarization state on the x-axis. Accordingly, the output left eye image may pass (i.e., be transmitted) through the left light polarization part 241. However, the output left eye image may not pass through the right light polarization part 242. This is because the left eye image is polarization on the x-axis, and the right light polarization part 242 makes only polarization on the y-axis . The output left eye image may be seen to the user through the left light polarization part 241 of the 3D glasses 200.

While the left eye image is being output, the electronic apparatus 100 may obtain an illumination value through the illumination sensor 151 and the illumination polarization film 152. The electronic apparatus 100 may obtain an illumination value for the ambient environment of the place wherein the electronic apparatus 100 is arranged. The electronic apparatus 100 may obtain a light that passed through the illumination polarization film 152 through the illumination sensor 151.

As an example, the illumination polarization film 152 may be implemented as a first polarization film. The first polarization film may be a polarization module in the polarization state on the x-axis.

In case the illumination polarization film 152 makes polarization on the x-axis , a light corresponding to the left eye image may the illumination polarization film 152 and reach the illumination sensor 151. The illumination sensor 151 may sense or detect a light corresponding to the left eye image. In case the left eye image includes a dark background, the illumination sensor 151 may sense a relatively low illumination value.

Referring to the embodiment 1020 in FIG. 10, the DLP outputter may output a right eye image. The output right eye image may be output through the DLP panel and the variable polarization film 142.

The DLP outputter may transmit a second sync signal for controlling the variable polarization film 142 to a polarization state of the right eye image on the y-axis to the variable polarization film 142. The variable polarization film 142 may operate in the polarization state on the y-axis based on the second sync signal.

The user may wear 3D glasses 200. The 3D glasses 200 may include a left light polarization part 241 and a right light polarization part 242. As an example, the left light polarization part 241 may be a light polarization part in a polarization state on the y-axis. As an example, the right light polarization part 242 may be a light polarization part in a polarization state on the y-axis.

The right eye image may be an image that was output through the variable polarization film 142 in the polarization state on the y-axis. Accordingly, the output right eye image may pass through the right light polarization part 242. However, the output right eye image may not pass through the left light polarization part 241. This is because the right eye image is polarized along the y-axis, and the left light polarization part 241 transmits only light that is polarized along the x-axis . The output right eye image may be seen to the user through the right light polarization part 242 of the 3D glasses 200.

While the right eye image is being output, the electronic apparatus 100 may obtain an illumination value through the illumination sensor 151 and the illumination polarization film 152. The electronic apparatus 100 may obtain an illumination value for the ambient environment of the place wherein the electronic apparatus 100 is arranged. The electronic apparatus 100 may obtain, through the illumination sensor 151, a light that passed through the illumination polarization film 152.

As an example, the illumination polarization film 152 may be implemented as a first polarization film. The first polarization film may be a polarization module in the polarization state on the x-axis.

If the illumination polarization film 152 is configured to transmit a light polarized along the x-axis , a light corresponding to the right eye image may not pass through the illumination polarization film 152. This is because the right eye image output by the variable polarization film 142 is polarized along the y-axis. The illumination sensor 151 may not sense a light corresponding to the right eye image. In case the right eye image includes a bright background, the illumination sensor 151 may not sense a bright light corresponding to the right eye image.

In FIG. 10, it was described that the illumination polarization film 152 is a first polarization film that makes polarization on the x-axis .

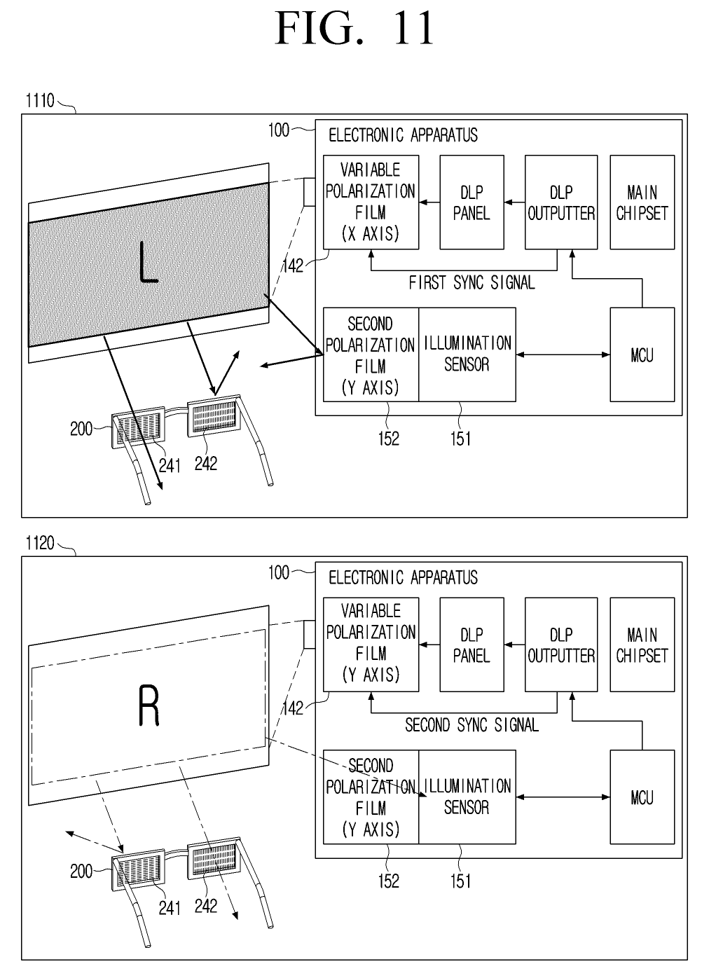

In FIG. 11, the illumination polarization film 152 may be a second polarization film that transmits a light polarized along the y-axis . The illumination polarization film 152 may be implemented as a second polarization film.

FIG. 11 is a diagram for illustrating an example of providing a 3D effect by transmitting light that is polarized along a y-axis according to one or more embodiments.

The second polarization film may indicate a polarization film in a second state. The second polarization film in the second state may be configured to transmit a light oriented in the second direction. The embodiments 1110 and 1120 in FIG. 11 may correspond to the embodiments 1010 and 1020 in FIG. 10. Accordingly, overlapping explanation will be omitted.

Referring to the embodiment 1110 in FIG. 11, the user may wear 3D glasses 200. The left eye image may be an image that was output through the variable polarization film 142 in a polarization state along the x-axis. Accordingly, the output left eye image may pass through the left light polarization part 241. However, the output left eye image may not pass through the right light polarization part 242. This is because the left eye image is polarization on the x-axis, and the right light polarization part 242 only transmits light polarized along the y-axis. The output left eye image may be seen by the user through the left light polarization part 241 of the 3D glasses 200.

While the left eye image is being output, the electronic apparatus 100 may obtain an illumination value through the illumination sensor 151 and the illumination polarization film 152. The electronic apparatus 100 may obtain an illumination value for the ambient environment of the place wherein the electronic apparatus 100 is arranged. The electronic apparatus 100 may obtain a light that passed through the illumination polarization film 152 through the illumination sensor 151.

As an example, the illumination polarization film 152 may be implemented as a second polarization film. The second polarization film may be a polarization module in the polarization state on the y-axis.

In case the illumination polarization film 152 transmits light polarized along the y-axis , a light corresponding to the left eye image may not pass through the illumination polarization film 152. This is because the left eye image is polarized along the x-axis output by the variable polarization film 142. The illumination sensor 151 may not sense a light corresponding to the left eye image. In case the left eye image includes a dark background, the illumination sensor 151 may not sense a dark light corresponding to the left eye image.

Referring to the embodiment 1120 in FIG. 11, the user may wear 3D glasses 200. The right eye image may be an image that was output through the variable polarization film 142 in a polarization state on the y-axis. Accordingly, the output right eye image may not pass through the left light polarization part 241. This is because the right eye image is polarized along the y-axis, and the left light polarization part 241 only transmits light that is polarized along the x-axis. However, the output right eye image may pass through the right light polarization part 242. The output right eye image may be seen by the user through the right light polarization part 242 of the 3D glasses 200.

While the right eye image is being output, the electronic apparatus 100 may obtain an illumination value through the illumination sensor 151 and the illumination polarization film 152. The electronic apparatus 100 may obtain an illumination value for the ambient environment of the place wherein the electronic apparatus 100 is arranged. The electronic apparatus 100 may obtain a light that passed through the illumination polarization film 152 through the illumination sensor 151.

As an example, the illumination polarization film 152 may be implemented as a second polarization film. The second polarization film may be a polarization module in the polarization state on the y-axis.

In case the illumination polarization film 152 makes polarization on the y-axis , a light corresponding to the right eye image may the illumination polarization film 152. This is because the right eye image is polarization on the y-axis output by the variable polarization film 142. The illumination sensor 151 may sense a light corresponding to the right eye image. In case the right eye image includes a bright background, the illumination sensor 151 may sense a bright light corresponding to the right eye image.

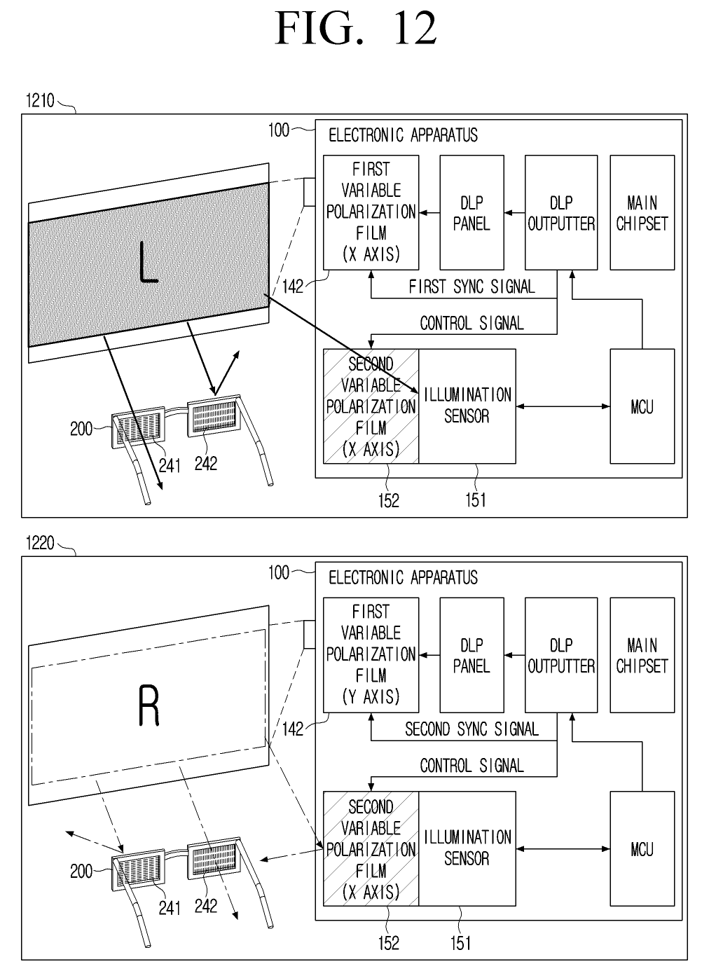

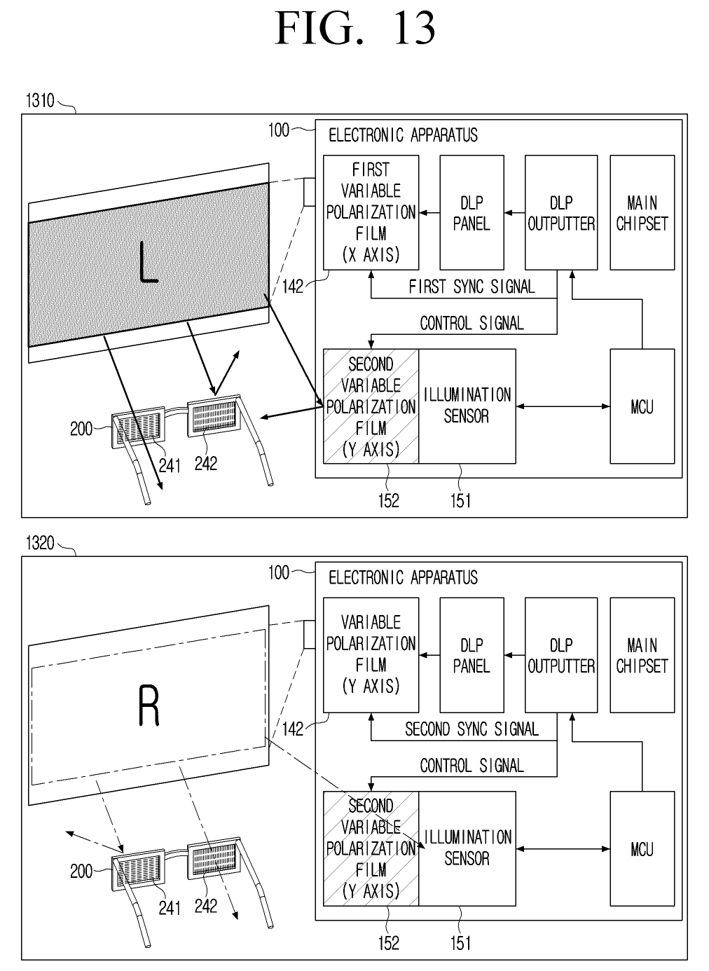

In FIG. 10 and FIG. 11, it was described that the illumination polarization film 152 is a polarization film in a fixed state. The illumination polarization film 152 in FIG. 10 and FIG. 11 may be a fixed type polarization film whose state is not changed according to control by the electronic apparatus 100. However, in FIG. 12 and FIG. 13, the state of the illumination polarization film 152 may vary according to control by the electronic apparatus 100. The illumination polarization film 152 may be implemented as a variable polarization film. For the convenience of distinction, the variable polarization film 142 may be described as a first variable polarization film, and the illumination polarization film 152 may be described as a second variable polarization film.

FIG. 12 is a diagram for illustrating an example of providing a 3D effect by polarizing light along an x-axis in a plurality of variable polarization films according to one or more embodiments.

The embodiments 1210 and 1220 in FIG. 12 may correspond to the embodiments 1010 and 1020 in FIG. 10 excluding the feature that the illumination polarization film 152 is a variable polarization film. Accordingly, overlapping explanation will be omitted.

The illumination polarization film 152 may be a second variable polarization film in a polarization state on the x-axis. The electronic apparatus 100 may transmit a control signal to the illumination polarization film 152 so that it gets in a polarization state on the x-axis.

Referring to the embodiment 1210 in FIG. 12, the electronic apparatus 100 may output a left eye image of polarization on the x-axis through the variable polarization film 142. The illumination sensor 151 may sense the polarization on the x-axis corresponding to the left eye image through the illumination polarization film 152.

Referring to the embodiment 1220 in FIG. 12, the electronic apparatus 100 may output a right eye image of polarization on the y-axis through the variable polarization film 142. The illumination sensor 151 may not sense the polarization on the y-axis corresponding to the right eye image. This is because the polarization on the y-axis corresponding to the right eye image may not pass through the illumination polarization film 152 that only transmits light polarized along the x-axis .

FIG. 13 is a diagram for illustrating an example of providing a 3D effect by using polarization on a y-axis in a plurality of variable polarization films according to one or more embodiments.

The embodiments 1310 and 1320 in FIG. 13 may correspond to the embodiments 1110 and 1120 in FIG. 11 excluding the feature that the illumination polarization film 152 is a variable polarization film. Accordingly, overlapping and/or redundant explanation(s) may be omitted.

The illumination polarization film 152 may be a second variable polarization film in a polarization state on the y-axis. The electronic apparatus 100 may transmit a control signal to the illumination polarization film 152 so that it changes to a state configured to transmit light polarized along the y-axis.

Referring to the embodiment 1310 in FIG. 13, the electronic apparatus 100 may output a left eye image of polarization on the x-axis through the variable polarization film 142. The illumination sensor 151 may not sense the polarization on the x-axis corresponding to the left eye image. This is because the polarization on the x-axis corresponding to the left eye image may not the illumination polarization film 152 that makes only polarization on the y-axis .

Referring to the embodiment 1320 in FIG. 13, the electronic apparatus 100 may output a right eye image of polarization on the y-axis through the variable polarization film 142. The illumination sensor 151 may sense polarization on the y-axis corresponding to the right eye image through the illumination polarization film 152.

FIG. 8 to FIG. 13 described an operation of outputting a projection image on a projection surface through the image outputter. FIG. 14 and FIG. 15 will describe an operation of outputting an image through the display 140. The image output module 141 may include the display 140.

FIG. 14 is a diagram for illustrating an operation of outputting an image through the display 140 according to one or more embodiments.

Referring to the embodiment 1410 in FIG. 14, the electronic apparatus 100 may display a left eye image (a first test image) through the display 140.

Referring to the embodiment 1420 in FIG. 14, the electronic apparatus 100 may display a right eye image (a second test image) through the display 140.

The electronic apparatus 100 may alternately display the left eye image and the right eye image based on the first timing information. The first timing information may include a first section and a second section. The electronic apparatus 100 may display the left eye image in the first section, and display the right eye image in the second section.

FIG. 15 is a diagram for illustrating an operation of outputting an image through the display 140 according to one or more embodiments.

Referring to the embodiment 1500 in FIG. 15, the electronic apparatus 100 may include at least one of at least one processor 120, a display 140, an image output module 141, a variable polarization film 142, an illumination sensor 151, or an illumination polarization film 152.

The at least one processor 120 may obtain a test image. The at least one processor 120 may generate a control signal for outputting the test image. The at least one processor 120 may transmit the control signal to the image output module 141. The image output module 141 may control the display 140 to output the test image based on the received control signal.

A light corresponding to the test image output from the display 140 may pass through the variable polarization film 142, and may be spread to the outside of the electronic apparatus 100.

FIG. 16 is a diagram for illustrating a test image according to one or more embodiments.

Referring to the embodiment 1600 in FIG. 16, the electronic apparatus 100 may obtain a test image. The test image may include a first test image and a second test image. As an example, the first test image may be a left eye image, and the second test image may be a right eye image.

The electronic apparatus 100 may alternately output the first test image and the second test image based on the first timing information. The first timing information may include a first section and a second section. The first section may be a section for outputting the first test image. The second section may be a section for outputting the second test image.

The first timing information may include a first cycle (or a first pattern) wherein the first section and the second section are repeated.

The electronic apparatus 100 may output the first test image 1610 on a first time point t1. The electronic apparatus 100 may output the first test image 1610 in the first section included in the first timing information.

The electronic apparatus 100 may output the second test image 1620 on a second time point t2. The electronic apparatus 100 may output the second test image 1620 in the second section included in the first timing information.

The electronic apparatus 100 may output the first test image 1610 on a third time point t3. The electronic apparatus 100 may output the first test image 1610 in the first section included in the first timing information.

The electronic apparatus 100 may output the second test image 1620 on a fourth time point t4. The electronic apparatus 100 may output the second test image 1620 in the second section included in the first timing information.

The first test image 1610 and the second test image 1620 may be alternately displayed based on the first cycle included in the first timing information.

FIG. 17 is a diagram for illustrating a situation wherein a test image is output normally according to one or more embodiments.

Referring to the embodiment 1700 in FIG. 17, the electronic apparatus 100 may control the image output module 141 based on the first timing information. The image output module 141 may output the first test image and the second test image based on the first timing information.

The electronic apparatus 100 may control the variable polarization film 142 based on the second timing information. The variable polarization film 142 may alternately change the first state for polarization on the x-axis and the second state for polarization on the y-axis based on the second timing information.

In the first section p1, the electronic apparatus 100 may output the first test image. A light corresponding to the first test image may pass through the variable polarization film 142 configured to transmit light polarized along the x-axis, and may be output to the outside of the electronic apparatus 100. The light corresponding to the first test image output to the outside may have a characteristic of polarization along the x-axis. The electronic apparatus 100 may obtain an illumination value (sensing data) through the illumination sensor 151. The illumination sensor 151 may sense the light corresponding to the first test image through the illumination polarization film 152. In case the illumination polarization film 152 has a characteristic of transmitting light polarized along the x-axis, the illumination sensor 151 may sense the light corresponding to the first test image (polarization on the x-axis).

In the second section p2, the electronic apparatus 100 may output the second test image. A light corresponding to the second test image may pass through the variable polarization film 142 configured to transmit light polarized along the y-axis , and may be output to the outside of the electronic apparatus 100. The light corresponding to the second test image output to the outside may have a characteristic of polarization on the y-axis. The electronic apparatus 100 may obtain an illumination value (sensing data) through the illumination sensor 151. The illumination sensor 151 may not sense the light corresponding to the second test image through the illumination polarization film 152. In case the illumination polarization film 152 has a characteristic of transmitting light polarized along the x-axis , the illumination sensor 151 may not sense the light corresponding to the second test image (polarization on the y-axis).

FIG. 18 is a diagram for illustrating an illumination value that is obtained in a situation wherein a test image is output normally according to one or more embodiments.

The embodiment 1810 in FIG. 18 may correspond to the embodiment 1700 in FIG. 17. Accordingly, overlapping and/or redundant explanation(s) may be omitted.

The embodiment 1820 in FIG. 18 indicates a case wherein the space where the electronic apparatus 100 is arranged is a bright room (a bright space). The bright space may mean a space wherein the absolute illumination value is greater than or equal to threshold illumination.

The electronic apparatus 100 may obtain basic illumination value information 1821 corresponding to the bright space. The basic illumination value information 1821 may include at least one of a reference illumination value 100 that is sensed in case a right eye image is output, a reference illumination value 40 that is sensed in case a left eye image is output, or an illumination value around the bright room 20. The illumination value around the bright room 20 may be obtained by a sensing operation of the illumination sensor 151. The unit of the illumination value may be lux (lx), lumens (lm), or Watts (W), but it not limited thereto.

The electronic apparatus 100 may measure the ambient illumination by using the illumination sensor 151. The electronic apparatus 100 may obtain analyzed illumination value information 1822 in the first section p1 and the second section p2.

The analyzed illumination value information 1822 may include at least one representative value.

As an example, the representative value may include at least one of a minimum value, a maximum value, or an average value. As an example, the average value may mean an average value of all illumination values obtained during a measurement time of illumination.

As an example, the representative value may include at least one of a minimum value, a maximum value, an average value, a minimum value of the first section p1, a maximum value of the first section p1, an average value of the first section p1, a minimum value of the second section p2, a maximum value of the second section p2, or an average value of the second section p2.

The embodiment 1830 in FIG. 18 indicates a case wherein the space where the electronic apparatus 100 is arranged is a dark room (a dark space). The dark space may mean a space wherein the absolute illumination value is smaller than or equal to the threshold illumination.

The electronic apparatus 100 may obtain basic illumination value information 1831 corresponding to the dark space. The basic illumination value information 1831 may include at least one of a reference illumination value 100 that is sensed in case a right eye image is output, a reference illumination value 40 that is sensed in case a left eye image is output, or an illumination value around the dark room 0. The illumination value around the dark room 0 may be obtained by a sensing operation of the illumination sensor 151.

The electronic apparatus 100 may measure the ambient illumination by using the illumination sensor 151. The electronic apparatus 100 may obtain analyzed illumination value information 1832 in the first section p1 and the second section p2.

The analyzed illumination value information 1832 may include at least one representative value.

As an example, the representative value may include at least one of a minimum value, a maximum value, or an average value. As an example, the average value may mean an average value of all illumination values obtained during a measurement time of illumination.

As an example, the representative value may include at least one of a minimum value, a maximum value, an average value, a minimum value of the first section p1, a maximum value of the first section p1, an average value of the first section p1, a minimum value of the second section p2, a maximum value of the second section p2, or an average value of the second section p2.

In FIG. 18, the timing when a left eye image is output and the timing when the variable polarization film 142 is controlled in the first state for polarization on the x-axis may correctly coincide (i.e., operate synchronously within a desired threshold of time, frequency, and/or any other appropriate operational parameter). Accordingly, the minimum values, the maximum values, and the average values of each of the first section p1 and the second section p2 may coincide.

FIG. 19 indicates a situation wherein the timing when the left eye image is output and the timing when the variable polarization film 142 is controlled in the first state for polarization on the x-axis do not correctly coincide.

FIG. 19 is a diagram for illustrating a situation wherein a test image is output abnormally according to one or more embodiments.

The embodiment 1900 in FIG. 19 may correspond to the embodiment 1700 in FIG. 17. Accordingly, overlapping and/or redundant explanation(s) may be omitted.

In the same manner as the embodiment 1700 in FIG. 17, in the embodiment 1900 in FIG. 19, the electronic apparatus 100 may alternately output the first test image and the second test image by controlling the image output module 141 based on the first timing information. The electronic apparatus 100 may alternately control the variable polarization film 142 in the first state (polarization on the x-axis) or the second state (polarization on the y-axis) based on the second timing information.

The second timing information may be generated based on the first timing information. The electronic apparatus 100 may obtain a third section based on the first section included in the first timing information, and obtain a fourth section based on the second section included in the first timing information. The electronic apparatus 100 may obtain the second timing information including the third section and the fourth section. The third section may correspond to the first section. The fourth section may correspond to the second section.

However, according to various causes, the conversion timing of the test image and the conversion timing of the state of the variable polarization film 142 may not coincide. This is because the time point when an actual conversion operation is performed varies due to the processing speed of performing a control command, even if the timing information coincides. As an example, the timings may not coincide due to a difference between the conversion processing speeds of the image output module 141 and the variable polarization film 142.

In case the timings do not coincide, as in the embodiment 1900 in FIG. 19, the state of the variable polarization film 142 and the output timing of the test image may not be matched (i.e., synchronized). If the timing does not match, polarization on the x-axis corresponding to a left eye image and polarization on the x-axis corresponding to a right eye image may be alternately sensed.

Unlike in the embodiment 1700 in FIG. 17, polarization on the x-axis corresponding to the left eye image may be sensed less by the illumination sensor 151. As an example, in case the left eye image has a dark background, the illumination sensor 151 may sense a higher illumination value compared to the embodiment 1700 in FIG. 17.

FIG. 20 is a diagram for illustrating an illumination value that is obtained in a situation wherein a test image is output abnormally according to one or more embodiments.

The embodiment 2010 in FIG. 20 may correspond to the embodiment 1900 in FIG. 19. Accordingly, overlapping and/or redundant explanation(s) may be omitted.

The embodiment 2010 in FIG. 20 indicates a case wherein the space where the electronic apparatus 100 is arranged is a bright room (a bright space). The bright space may mean a space wherein the absolute illumination value is greater than or equal to threshold illumination.

The electronic apparatus 100 may obtain basic illumination value information 2021 corresponding to the bright space. The basic illumination value information 2021 may include at least one of a reference illumination value 100 that is sensed in case a right eye image is output, a reference illumination value 40 that is sensed in case a left eye image is output, or an illumination value around the bright room 20. The illumination value around the bright room 20 may be obtained by a sensing operation of the illumination sensor 151.

The electronic apparatus 100 may measure the ambient illumination by using the illumination sensor 151. The electronic apparatus 100 may obtain analyzed illumination value information 2022 in the first section p1 and the second section p2.

The analyzed illumination value information 2022 may include at least one representative value. Explanation related to the representative value was described in FIG. 18 and FIG. 19.

The embodiment 2030 in FIG. 20 indicates a case wherein the space where the electronic apparatus 100 is arranged is a dark room (a dark space). The dark space may mean a space wherein the absolute illumination value is smaller than or equal to the threshold illumination.

The electronic apparatus 100 may obtain basic illumination value information 2031 corresponding to the dark space. The basic illumination value information 2031 may include at least one of a reference illumination value 100 that is sensed in case a right eye image is output, a reference illumination value 40 that is sensed in case a left eye image is output, or an illumination value around the dark room 0. The illumination value around the dark room 0 may be obtained by a sensing operation of the illumination sensor 151.

The electronic apparatus 100 may measure the ambient illumination by using the illumination sensor 151. The electronic apparatus 100 may obtain analyzed illumination value information 2032 in the first section p1 and the second section p2.

The analyzed illumination value information 2032 may include at least one representative value. Explanation related to the representative value was described in FIG. 18 and FIG. 19.

The representative value of illumination values measured (or analyzed) in FIG. 20 may be higher than the representative value of illumination values measured (or analyzed) in FIG. 18. This is because the polarization on the x-axis of the right eye image including a bright background was sensed by some illumination sensors 151. The electronic apparatus 100 may perform a timing correcting operation based on such illumination values.

FIG. 21 is a diagram for illustrating a state of the variable polarization film 142 according to one or more embodiments.

Referring to the embodiment 2100 in FIG. 21, the electronic apparatus 100 may control the variable polarization film 142. The variable polarization film 142 may be a film for transmitting a light oriented in a specific direction .

The electronic apparatus 100 may control the variable polarization film 142 based on the second timing information. The second timing information may include a third section and a fourth section. Also, the second timing information may include a second cycle (or a second pattern) wherein the third section and the fourth section are repeated.

The electronic apparatus 100 may control the variable polarization film 142 in the first state in the third section. The electronic apparatus 100 may control the variable polarization film 142 in the second state in the fourth section.

The variable polarization film 142 may have polarization characteristics in various states.

As an example, the first state may be polarization on the x-axis, and the second state may be polarization on the y-axis.

As an example, the first state may be polarization on the y-axis, and the second state may be polarization on the x-axis.

As an example, the first state may be polarization in a clockwise direction, and the second state may be polarization in a counter-clockwise direction.

As an example, the first state may be polarization in a counter-clockwise direction, and the second state may be polarization in a clockwise direction.

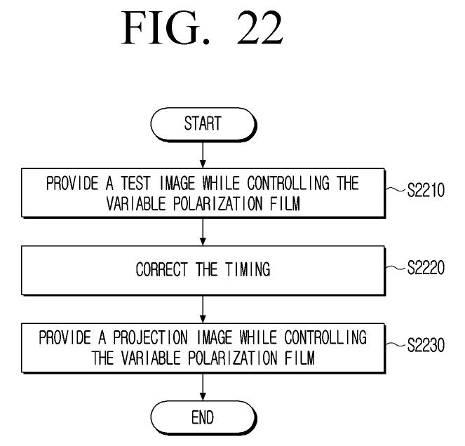

FIG. 22 is a diagram for illustrating an operation of providing a projection image by correcting timing according to one or more embodiments.

Referring to FIG. 22, the electronic apparatus 100 may provide a test image while controlling the variable polarization film 142 in the step S2210.

After providing the test image, the electronic apparatus 100 may perform timing correction in the step S2220. The timing correction may include an operation of correcting timing information that is used in an operation of outputting an image. The timing information may be described as cycle information, delay information, synchronization information, etc.

The timing correction may include an operation of correcting at least one of the first timing information or the second timing information used in an operation of providing a test image.

After performing the correcting operation, the electronic apparatus 100 may provide a projection image while controlling the variable polarization film 142 in the step S2230. The electronic apparatus 100 may provide the projection image based on the final target timing obtained through the test image.

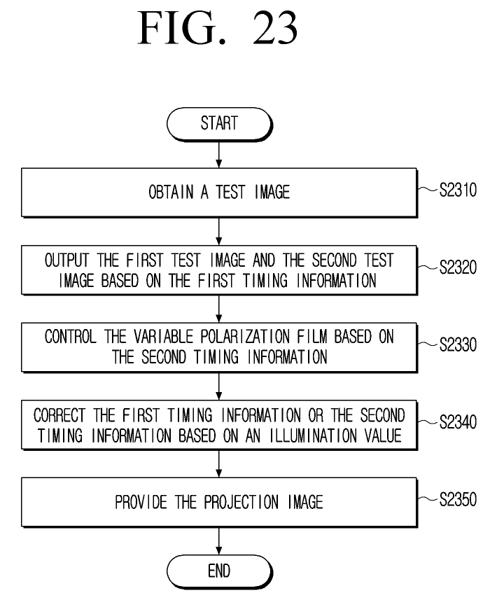

FIG. 23 is a diagram for illustrating first timing information applied to the image output module 141 and second timing information applied to the variable polarization film 142 according to one or more embodiments.

Referring to FIG. 23, the electronic apparatus 100 may obtain a test image in the step S2310. The test image may include a first test image and a second test image. The first test image may indicate a left eye image. The second test image may indicate a right eye image.

The electronic apparatus 100 may output the first test image and the second test image based on the first timing information in the step S2320. The electronic apparatus 100 may control the variable polarization film 142 based on the second timing information in the step S2330.

The electronic apparatus 100 may correct the first timing information or the second timing information based on an illumination value in the step S2340. The electronic apparatus 100 may correct a time point for displaying the first test image and the second test image, or correct a time point of converting the state of the variable polarization film 142.

The electronic apparatus 100 may store the correction result. The electronic apparatus 100 may provide a projection image based on the correction result in the step S2350. If correction is not needed, the electronic apparatus 100 may provide a projection image without correction.

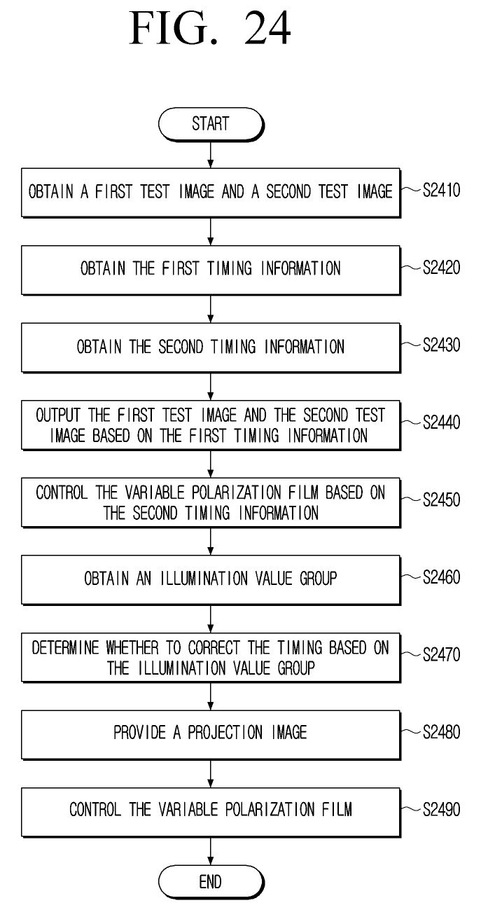

FIG. 24 is a diagram for illustrating an operation of providing a projection image and controlling the variable polarization film 142 by correcting timing based on an illumination value group according to one or more embodiments.

Referring to FIG. 24, the electronic apparatus 100 may obtain a first test image and a second test image in the step S2410. The electronic apparatus 100 may obtain the first timing information in the step S2420. The electronic apparatus 100 may obtain the first timing information used for outputting the first test image and the second test image.

The electronic apparatus 100 may obtain the second timing information in the step S2430. The electronic apparatus 100 may obtain the second timing information for controlling the variable polarization film 142.

The electronic apparatus 100 may output the first test image and the second test image based on the first timing information in the step S2440. The electronic apparatus 100 may output the first test image and the second test image based on the first timing information through the image output module 141.

The electronic apparatus 100 may control the variable polarization film 142 based on the second timing information in the step S2450. The electronic apparatus 100 may convert (or change) the state of the variable polarization film 142 based on the second timing information. The variable polarization film 142 may be converted to the first state or the second state.

The electronic apparatus 100 may obtain an illumination value group while outputting the test images in the step S2460. The electronic apparatus 100 may sense an illumination value for the ambient environment of the electronic apparatus 100 through the illumination sensor 151. The electronic apparatus 100 may obtain an illumination value group including a plurality of illumination values. The illumination value group may indicate data units grouped by a predetermined standard.

The electronic apparatus 100 may determine timing correction based on the illumination value group in the step S2470. The electronic apparatus 100 may perform timing correction by analyzing a plurality of illumination values included in the illumination value group. The timing correction may include an operation for correcting at least one of the first timing information or the second timing information.

The electronic apparatus 100 may determine whether to perform timing correction. After determining whether to perform timing correction, the electronic apparatus 100 may provide a projection image based on a result of the timing correction in the step S2480.

The electronic apparatus 100 may control the variable polarization film 142 while providing the projection image in the step S2490.

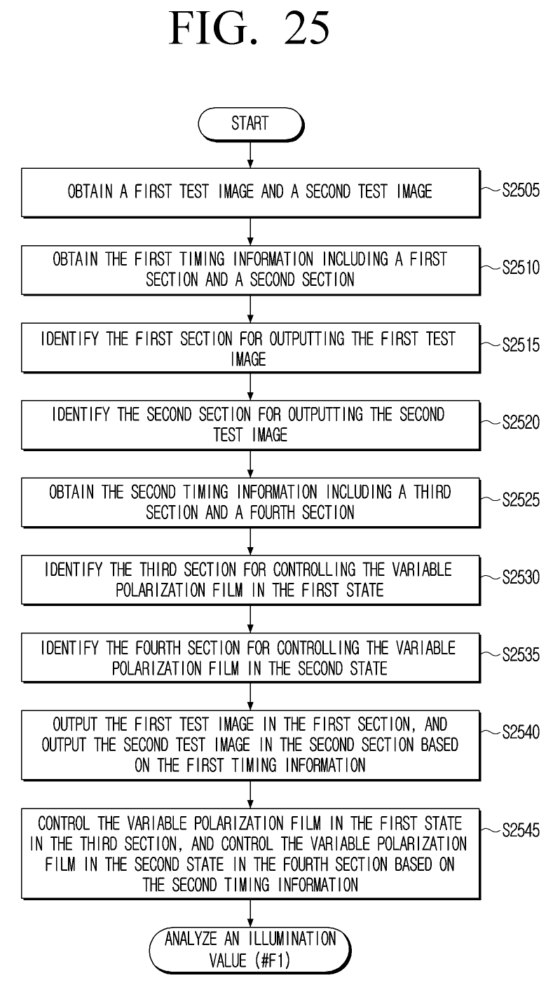

FIG. 25 is a diagram for illustrating an operation of outputting a test image according to one or more embodiments.

Referring to FIG. 25, the electronic apparatus 100 may obtain a first test image and a second test image in the step S2505. The electronic apparatus 100 may obtain the first timing information including a first section and a second section in the step S2510.

The electronic apparatus 100 may identify the first section for outputting the first test image based on the first timing information in the step S2515. The electronic apparatus 100 may identify the second section for outputting the second test image based on the second timing information in the step S2520.

The electronic apparatus 100 may obtain the second timing information including a third section and a fourth section in the step S2525. The electronic apparatus 100 may identify the third section based on the first section, and identify the fourth section based on the second section. The electronic apparatus 100 may generate the second timing information including the third section and the fourth section.

The electronic apparatus 100 may identify the third section for controlling the variable polarization film 142 in the first state based on the second timing information in the step S2530. The electronic apparatus 100 may identify the fourth section for controlling the variable polarization film 142 in the second state based on the second timing information in the step S2535.

The electronic apparatus 100 may output the first test image in the first section, and output the second test image in the second section based on the first timing information in the step S2540.

The electronic apparatus 100 may control the variable polarization film 142 in the first state in the third section, and control the variable polarization film 142 in the second state in the fourth section based on the second timing information in the step S2545.

The electronic apparatus 100 may perform an operation of analyzing an illumination value (#F1). Explanation in this regard will be described in FIG. 26.

FIG. 26 is a diagram for illustrating an operation of analyzing an illumination value according to one or more embodiments.

Referring to FIG. 26, the electronic apparatus may perform the operation of analyzing an illumination value (#F1). The electronic apparatus 100 may obtain an illumination value based on the illumination sensor 151 and a light received through the illumination polarization film 152 in the step S2605.

The electronic apparatus 100 may determine whether a threshold time passed from a time point when an illumination value was initially sensed in the step S2610. If the threshold time did not pass in the step S2610-N, the electronic apparatus 100 may repeat the operations S2605 and S2610. The threshold time may be changed according to the user’s setting(s).

When the threshold time passes from the time point when the illumination value was initially sensed in the step S2610-Y, the electronic apparatus 100 may obtain a first illumination value group during the threshold time in the step S2615. The first illumination value group may include a plurality of illumination values.

The electronic apparatus 100 may obtain a first representative value based on the first illumination value group in the step S2620. As an example, the first representative value may include at least one of an average value or a maximum value.

The electronic apparatus 100 may identify whether the first representative value is smaller than a threshold value in the step S2625. The threshold value may be changed according to the user’s setting(s).

As an example, if the first representative value is the average value, the threshold value may be a first threshold value.

As an example, if the first representative value is the maximum value, the threshold value may be a second threshold value. The second threshold value may be different from the first threshold value. The second threshold value may be greater than the first threshold value.

If the first representative value is greater than or substantially equal to the threshold value in the step S2625-N, the electronic apparatus 100 may perform a timing correcting operation (#F2). Explanation in this regard will be described in FIG. 27 and FIG. 28.

If the first representative value is less than the threshold value in the step S2625-Y, the electronic apparatus 100 may determine the first timing information as the first target timing, and determine the second timing information as the second target timing in the step S2635.

When the first target timing and the second target timing are determined, the electronic apparatus 100 may store the first target timing and the second target timing. The electronic apparatus 100 may provide a projection image based on the first target timing and the second target timing (#F3). Explanation in this regard will be described in FIG. 29.

FIG. 27 is a diagram for illustrating an operation of correcting timing according to one or more embodiments.

Referring to FIG. 27, the electronic apparatus 100 may perform a timing correcting operation (#F2). The electronic apparatus 100 may obtain delay information in the step S2705. The delay information may include information for delaying timing.

As an example, the electronic apparatus 100 may apply the delay information to the second timing information.

The electronic apparatus 100 may output the first test image in the first section and output the second test image in the second section based on the first timing information in the step S2710.

The electronic apparatus 100 may obtain the third timing information by updating the second timing information based on the delay information in the step S2715.

The electronic apparatus 100 may control the variable polarization film 142 in the first state in the third section, and control the variable polarization film 142 in the second state in the fourth section based on the third timing information in the step S2720.

The electronic apparatus 100 may obtain an illumination value based on the illumination sensor 151 and a light received through the illumination polarization film 152 in the step S2825. The electronic apparatus 100 may determine whether a threshold time passed from the time point of sensing by the operation of the step S2825 in the step S2830. The threshold time may be changed according to the user’s setting(s).

In case the threshold time did not pass in the step S2730-N, the electronic apparatus 100 may repeat the operations of the steps S2725 and S2730.

In case the threshold time passed in the step S2730-Y, the electronic apparatus 100 may obtain a second illumination value group during the threshold time in the step S2735. The second illumination value group may include a plurality of illumination values.

The electronic apparatus 100 may obtain a second representative value based on the second illumination value group in the step S2740. As an example, the second representative value may be an average value or a minimum value.

The electronic apparatus 100 may identify whether the second representative value is smaller than the threshold value in the step S2745. The threshold value may be changed according to the user’s setting(s).

As an example, if the second representative value is the average value, the threshold value may be a first threshold value.

As an example, if the second representative value is the maximum value, the threshold value may be a second threshold value. The second threshold value may be different from the first threshold value. The second threshold value may be bigger than the first threshold value.

If the second representative value is greater than or equal to the threshold value in the step S2745-N, the electronic apparatus 100 may repeat the operations of the steps S2705 to S2745. The electronic apparatus 100 may continuously correct the timing by changing the delay information.

If the second representative value is smaller than the threshold value in the step S2745-Y, the electronic apparatus 100 may determine the first timing information as the first target timing, and determine the third timing information as the second target timing in the step S2750.

The electronic apparatus 100 may store the first target timing and the second target timing. The electronic apparatus 100 may provide a projection image based on the first target timing and the second target timing (#F3). Explanation in this regard will be described in FIG. 29.

In FIG. 27, an operation of applying delay information to the second timing information was described. In FIG. 28, an operation of applying delay information to the first timing information will be explained.

FIG. 28 is a diagram for illustrating an operation of correcting timing according to one or more embodiments.

Referring to FIG. 28, the electronic apparatus 100 may perform a timing correcting operation (#F2). The electronic apparatus 100 may obtain delay information in the step S2805. The delay information may include information for delaying timing.

As an example, the electronic apparatus 100 may apply the delay information to the first timing information.

The electronic apparatus 100 may obtain the fourth timing information by updating the first timing information based on the delay information in the step S2810.

The electronic apparatus 100 may output a first test image in the first section and output a second test image in the second section based on the fourth timing information in the step S2815.

The electronic apparatus 100 may control the variable polarization film 142 in the first state in the third section, and control the variable polarization film 142 in the second state in the fourth section based on the second target timing in the step S2820.

The electronic apparatus 100 may obtain an illumination value based on the illumination sensor 151 and a light received through the illumination polarization film 152 in the step S2725. The electronic apparatus 100 may determine whether a threshold time passed from the time point of sensing by the operation of the step S2725 in the step S2730. The threshold time may be changed according to the user’s setting.

If the threshold time did not pass in the step S2830-N, the electronic apparatus 100 may repeat the operations of the steps S2825 and S2830.

If the threshold time passed in the step S2830-Y, the electronic apparatus 100 may obtain a third illumination value group during the threshold time in the step S2835. The third illumination value group may include a plurality of illumination values.

The electronic apparatus 100 may obtain a third representative value based on the third illumination value group in the step S2840. As an example, the third representative value may be an average value or a minimum value.

The electronic apparatus 100 may identify whether the third representative value is smaller than the threshold value in the step S2845. The threshold value may be changed according to the user’s setting(s).

As an example, if the third representative value is the average value, the threshold value may be a first threshold value.

As an example, if the third representative value is the maximum value, the threshold value may be a second threshold value. The second threshold value may be different from the first threshold value. The second threshold value may be bigger than the first threshold value.

If the third representative value is greater than or equal to the threshold value in the step S2845-N, the electronic apparatus 100 may repeat the operations of the steps S2805 to S2845. The electronic apparatus 100 may continuously correct the timing by changing the delay information.

If the third representative value is smaller than the threshold value in the step S2845-Y, the electronic apparatus 100 may determine the fourth timing information as the first target timing, and determine the second timing information as the second target timing in the step S2850.

The electronic apparatus 100 may store the first target timing and the second target timing. The electronic apparatus 100 may provide a projection image based on the first target timing and the second target timing (#F3). Explanation in this regard will be described in FIG. 29.

In FIG. 26 to FIG. 28, it was assumed that the illumination polarization film 152 is a polarization film on the x-axis. In case the illumination polarization film 152 is a polarization film on the y-axis, the electronic apparatus 100 may determine whether the representative value exceeds the threshold value. Only when the representative value exceeds the threshold value, the previous timing information may be determined as the target timing. This is because, if the illumination polarization film 152 is a polarization film on the y-axis, polarization on the y-axis corresponding to the relatively brighter second test image is sensed by the illumination sensor 151.

FIG. 29 is a diagram for illustrating an operation of providing a projection image according to one or more embodiments.

Referring to FIG. 29, the electronic apparatus 100 may perform an operation of providing a projection image (#F3). The electronic apparatus 100 may store the first target timing and the second target timing.

The electronic apparatus 100 may obtain the first projection image and the second projection image in the step S2905. As an example, the first projection image may be a left eye image, and the second projection image may be a right eye image. The projection images may be images for providing a 3D effect.

The electronic apparatus 100 may obtain the first target timing including the first section and the second section in the step S2910.

The electronic apparatus 100 may identify the first section for outputting the first projection image based on the first target timing in the step S2915.

The electronic apparatus 100 may identify the second section for outputting the second projection image based on the first target timing in the step S2925.

The electronic apparatus 100 may obtain the second target timing including the third section and the fourth section in the step S2925.

The electronic apparatus 100 may identify the third section for controlling the variable polarization film 142 in the first state based on the second target timing in the step S2930.

The electronic apparatus 100 may identify the fourth section for controlling the variable polarization film 142 in the second state based on the second target timing in the step S2935.

The electronic apparatus 100 may output the first projection image in the first section and output the second projection image in the second section based on the first target timing in the step S2940.

The electronic apparatus 100 may control the variable polarization film 142 in the first state in the third section, and control the variable polarization film 142 in the second state in the fourth section based on the second timing information in the step S2945.

While the variable polarization film 142 is in the first state, the electronic apparatus 100 may output the first projection image. While the variable polarization film 142 is in the second state, the electronic apparatus 100 may output the second projection image.

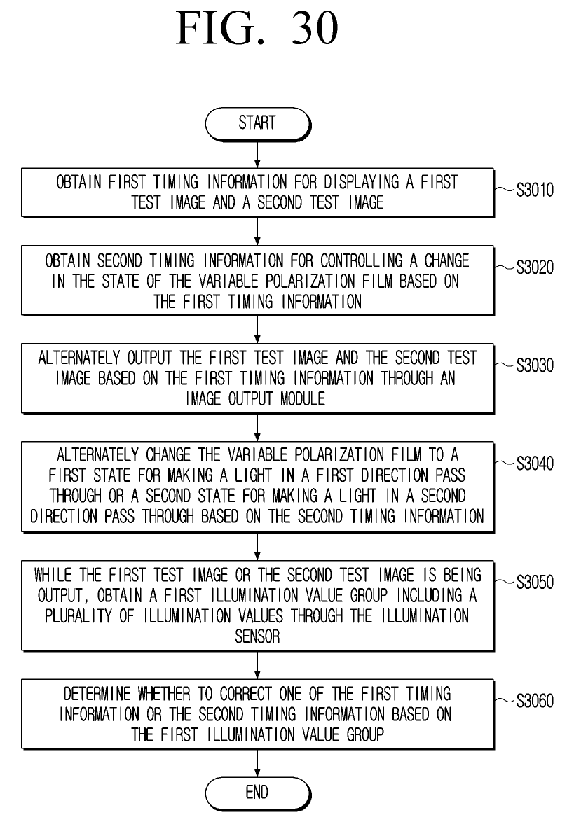

FIG. 30 is a diagram for illustrating a controlling method of the electronic apparatus 100 according to one or more embodiments.

Referring to FIG. 30, a controlling method of an electronic apparatus including a variable polarization film and an illumination sensor may include the steps of obtaining first timing information for displaying a first test image and a second test image (S3010), obtaining second timing information for controlling a change in the state of the variable polarization film based on the first timing information (S3020), alternately outputting the first test image and the second test image based on the first timing information through an image output module (S3030), alternately changing the variable polarization film to a first state for making a light in a first direction pass through or a second state for making a light in a second direction pass through based on the second timing information (S3040), and while the first test image or the second test image is being output, obtaining a first illumination value group including a plurality of illumination values through the illumination sensor (S3050), and determining whether to correct one of the first timing information or the second timing information based on the first illumination value group (S3060).

The first test image may be a left eye image for a 3D effect, and the second test image may be a right eye image for the 3D effect.

The first test image may include a background of a first color, and the second test image may include a background of a second color brighter than the first color.

The first state may be a state for making a light in a first direction pass through, and the second state may be a state for making a light in a second direction different from the first direction pass through.

The first state may be a state for making polarization on an x axis pass through, and the second state may be a state for making polarization on a y axis pass through.

In the step S3030 of outputting the first test image and a second test image, while the variable polarization film is controlled in the first state based on the second timing information, the first test image may be output based on the first timing information through the image output module, and while the variable polarization film is controlled in the second state based on the second timing information, the second test image may be output based on the first timing information through the image output module.

In the step S3060 of whether to perform correction, a first representative value may be obtained based on the first illumination value group, and based on the first representative value being smaller than a threshold value, the first timing information may be determined as first target timing, and the second timing information may be determined as second target timing. Also, the controlling method may include the step of outputting a projection image based on the first target timing and the second target timing through the image output module, and the first representative value may be one of a maximum value or an average value.

In the step S3060 of whether to perform correction, based on the first representative value being greater than or equal to the threshold value, delay information may be obtained, third timing information may be obtained by reflecting the delay information to the second timing information, and the variable polarization film may be alternately changed to the first state or the second state based on the third timing information.

In the step S3060 of whether to perform correction, while controlling the variable polarization film based on the third timing information, a second illumination value group including a plurality of illumination values may be obtained through the illumination sensor, a second representative value may be obtained based on the second illumination value group, and based on the second representative value being smaller than the threshold value, the first timing information may be determined as first target timing, and the third timing information may be determined as second target timing.

The illumination sensor may be a sensor that senses an illumination value based on a light that passes through an illumination polarization film for making a light in the first direction pass through.

Methods according to the aforementioned various embodiments of the disclosure may be implemented in forms of applications that can be installed on conventional electronic apparatuses.

Also, the methods according to the aforementioned various embodiments of the disclosure may be implemented just with software upgrade, or hardware upgrade of conventional electronic apparatuses.

In addition, the aforementioned various embodiments of the disclosure may also be performed through an embedded server provided on an electronic apparatus, or an external server of at least one of electronic apparatuses.

According to one or more embodiments of the disclosure, the aforementioned various embodiments may be implemented as software including instructions stored in machine-readable storage media, which can be read by machines (e.g., computers). The machines refer to apparatuses that call instructions stored in a storage medium, and can operate according to the called instructions, and the apparatuses may include the electronic apparatus according to the embodiments disclosed herein. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that the storage medium does not include signals, and is tangible, and the term does not distinguish a case wherein data is stored semi-permanently in a storage medium and a case wherein data is stored temporarily.

Also, according to one or more embodiments of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g., compact disc read only memory (CD-ROM)), or distributed on-line through an application store. In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g., a module or a program) according to the aforementioned various embodiments may consist of a singular object or a plurality of objects. Also, among the aforementioned corresponding sub components, some sub components may be omitted, or other sub components may be further included in the various embodiments. Alternatively or additionally, some components (e.g., a module or a program) may be integrated as an object, and perform functions performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the scope of the disclosure as claimed by the appended claims. Further, it is intended that such modifications are not to be interpreted independently from the technical idea of the disclosure.

What is claimed is:

1. An electronic apparatus comprising:
memory storing instructions;
at least one processor including processing circuitry;
an image output module;
a variable polarization film; and
an illumination sensor,
wherein the instructions, when executed by the at least one processor individually or collectively, cause the electronic apparatus to:
obtain first timing information to display a first test image and a second test image,
obtain second timing information to control a change in the state of the variable polarization film based on the first timing information,
alternately output, through the image output module, the first test image and the second test image based on the first timing information,
alternately change, based on the second timing information, the variable polarization film to a first state configured to transmit a light oriented in a first direction or a second state configured to transmit a light oriented in a second direction,
while the first test image or the second test image is being output, obtain, through the illumination sensor, a first illumination value group including a plurality of illumination values, and
determine whether to correct one of the first timing information or the second timing information based on the first illumination value group.

2. The electronic apparatus of claim 1,
wherein the first test image is a left eye image configured to produce a 3D effect, and
the second test image is a right eye image configured to produce the 3D effect.

3. The electronic apparatus of claim 2,
wherein the first test image comprises a background of a first color, and
the second test image comprises a background of a second color brighter than the first color.

4. The electronic apparatus of claim 1,
wherein the first state is a state configured to transmit a light oriented in the first direction, and
the second state is a state configured to transmit a light oriented in the second direction, wherein the second direction is different from the first direction.

5. The electronic apparatus of claim 4,
wherein the first state is a state configured to transmit light polarized along an x-axis, and
the second state is a state configured to transmit light polarized along a y-axis.

6. The electronic apparatus of claim 4,
wherein the instructions, when executed by the at least one processor individually or collectively, further cause the electronic apparatus to:
while the variable polarization film is controlled in the first state based on the second timing information, output, through the image output module, the first test image based on the first timing information, and
while the variable polarization film is controlled in the second state based on the second timing information, output, through the image output module, the second test image based on the first timing information.

7. The electronic apparatus of claim 1,
wherein the instructions, when executed by the at least one processor individually or collectively, further cause the electronic apparatus to:
obtain a first representative value based on the first illumination value group;
based on the first representative value being smaller than a threshold value:
determine the first timing information as first target timing; and
determine the second timing information as second target timing; and
output, through the image output module, a projection image based on the first target timing and the second target timing,
wherein the first representative value is one of a maximum value or an average value.

8. The electronic apparatus of claim 7,
wherein the instructions, when executed by the at least one processor individually or collectively, further cause the electronic apparatus to:
based on the first representative value being greater than or equal to the threshold value, obtain delay information,
obtain third timing information by updating the second timing information based on the delay information, and
alternately change the variable polarization film to the first state or the second state based on the third timing information.

9. The electronic apparatus of claim 8,
wherein the instructions, when executed by the at least one processor individually or collectively, further cause the electronic apparatus to:
while controlling the variable polarization film based on the third timing information, obtain, through the illumination sensor, a second illumination value group including a plurality of illumination values,
obtain a second representative value based on the second illumination value group, and
based on the second representative value being smaller than the threshold value, determine the first timing information as the first target timing, and determine the third timing information as the second target timing.

10. The electronic apparatus of claim 1,
wherein the illumination sensor is a sensor that senses an illumination value based on a light that passes through an illumination polarization film configured to transmit a light oriented in the first direction.

11. A controlling method of an electronic apparatus comprising a variable polarization film, an illumination sensor and an image output module, the controlling method comprising:
obtaining first timing information for displaying a first test image and a second test image;
obtaining second timing information for controlling a change in the state of the variable polarization film based on the first timing information;
alternately outputting, through the image output module, the first test image and the second test image based on the first timing information;
alternately changing the variable polarization film to a first state configured to transmit a light oriented in a first direction or a second state configured to transmit a light oriented in a second direction based on the second timing information;
while the first test image or the second test image is being output, obtaining, through the illumination sensor, a first illumination value group including a plurality of illumination values; and
determining whether to correct one of the first timing information or the second timing information based on the first illumination value group.

12. The controlling method of claim 11,
wherein the first test image is a left eye image configured to produce a 3D effect, and
the second test image is a right eye image configured to produce the 3D effect.

13. The controlling method of claim 12,
wherein the first test image comprises a background of a first color, and
the second test image comprises a background of a second color brighter than the first color.

14. The controlling method of claim 11,
wherein the first state is a state configured to transmit a light oriented in the first direction, and
the second state is a state configured to transmit a light oriented in the second direction, wherein the second direction is different from the first direction.

15. The controlling method of claim 14,
wherein the first state is a state configured to transmit light polarized along an x-axis, and
the second state is a state configured to transmit light polarized along a y-axis.
